(19) United States
(12) Patent Application Publication
(10) Pub. No.: US 2023/0283850 A1
(43) Pub. Date: Sep. 7, 2023

(54) COMPUTER PROGRAM, METHOD, AND SERVER DEVICE

(71) Applicant: GREE, INC., Tokyo (JP)

(72) Inventor: Masashi WATANABE, Tokyo (JP)

(73) Assignee: GREE, INC., Tokyo (JP)

(21) Appl. No.: 18/131,667

(22) Filed: Apr. 6, 2023

Related U.S. Application Data
(63) Continuation of application No. PCT/JP2021/048484, filed on Dec. 27, 2021.

(30) Foreign Application Priority Data
Jan. 27, 2021 (JP) 2021-010925

(51) Int. Cl. H04N 21/472; H04N 21/4788; H04N 21/482

(52) U.S. Cl. CPC H04N 21/47202; H04N 21/4788; H04N 21/4821; H04N 21/47217

(57) ABSTRACT

A computer program causes at least one processor to perform the following functions: displaying, based on operation data indicating content of an operation of a user, a virtual space that accommodates a virtual public venue for showing a video; displaying an entry-allowed time slot that includes at least (i) a show start time that is specified for the public venue and (ii) an entry end time obtained by adding an allowed time to the show start time; determining whether a time at which the public venue was selected based on the operation data as a venue to be entered is included in the entry-allowed time slot of the public venue; and in response to determining that the time at which the public venue is selected is included in the entry-allowed time slot, receiving a video specified for the public venue from a server device and displaying the video.

This application is a bypass continuation of PCT/JP2021/048484, filed Dec. 27, 2021, which claims the benefit of priority from Japanese Patent Application No. 2021-010925 filed Jan. 27, 2021, the entire contents of the prior applications being incorporated herein by reference.

### TECHNICAL FIELD

Technology disclosed in this application relates to a computer program, a method, and a server device used for distributing videos to a user terminal device.

### BACKGROUND TECHNOLOGY

There are known services that distribute videos to users’ terminal devices.

### SUMMARY

### Problem to Be Resolved

Recently, there has been a demand for expanding the venues for showing content such as new movies and live performances. In addition to simply distributing content to individuals, the personal experience of sharing the content among multiple users viewing the content (communication) may be important.

Furthermore, by multiple users sharing and viewing of the same content (for example, live distribution), it is possible to realize communication related to the content among these multiple users. However, in this case, it is conceivable that the content distribution may not be stable due to the influence of the quality and condition of the communication lines between the server device and each user’s terminal device. As a result, for example, if content distribution begins at a scheduled time, some users may not be able to access the content by that time.

Accordingly, the technology disclosed in this application provides a computer program, method, and server device for distributing videos to a user’s terminal device by improved methods in order to address the above-described problems.

### Means of Solving Problem(s)

A computer program according to one aspect can, “by being executed by at least one processor, cause the at least one processor to perform the following functions: displaying, based on operation data indicating content of an operation of a user, a virtual space that accommodates a public venue for showing a video; displaying an entry-allowed time slot that includes at least (i) a show start time that is specified for the public venue to (ii) an end time obtained by adding an allowed time to the show start time; determining whether a time at which the public venue was selected based on the operation data as a venue to be entered is included in the entry-allowed time slot of the public venue; and when it is determined that the time at which the public venue is selected is included in the entry-allowed time slot, receiving a video specified for the public venue from a server device and displaying the video.”

A method according to one aspect can be “a method executed by at least one processor that executes computer-readable commands, the method comprising, by the at least one processor executing the commands: displaying, based on operation data indicating content of an operation of a user, a virtual space that accommodates a public venue for showing a video; displaying an entry-allowed time slot that includes at least (i) a show start time that is specified for the public venue to (ii) an end time obtained by adding an allowed time to the show start time; determining whether a time at which the public venue is selected based on the operation data as a venue to be entered is included in the entry-allowed time slot of the public venue; and when it is determined that the time at which the public venue is selected is included in the entry-allowed time slot, receiving a video specified for the public venue from a server device and displaying the video.”

A method according to a separate aspect can be “a method executed by at least one processor that executes computer-readable commands, the method comprising, by the at least one processor executing the commands: sending, to a terminal device of a user, data related to an entry-allowed time slot that includes at least (i) a show start time that is specified for a public venue, accommodated in a virtual space, for showing a video to (ii) an end time obtained by adding an allowed time to the show start time; determining whether a time at which the public venue was selected by the terminal device as a venue to be entered is included in the entry-allowed time slot of the public venue; and when it is determined that the time at which the public venue was selected is included in the entry-allowed time slot, sending, to the terminal device, a video specified for the public venue.”

A server device according to one aspect can be “provided with at least one processor, the at least one processor being configured to perform the following functions: sending, to a terminal device of a user, data relating to an entry-allowed time slot that includes at least (i) a show start time that is specified for a public venue, accommodated in a virtual space, for showing a video to (ii) an end time obtained by adding an allowed time to the show start time; determining whether a time at which the public venue was selected by the terminal device as a venue to be entered is included in the entry-allowed time slot of the public venue; and when it is determined that the time at which the public venue was selected is included in the entry-allowed time slot, sending, to the terminal device, a video specified for the public venue.”

### BRIEF EXPLANATION OF DRAWINGS

FIG. 1 is a block diagram showing an example of a configuration of a video distribution system according to one embodiment.

FIG. 2 is a block diagram schematically showing an example of a hardware configuration of the terminal device 10 (server device 20) shown in FIG. 1.

FIG. 3 is a block diagram showing an example of functions of each terminal device 10 shown in FIG. 1.

FIG. 4A is a block diagram schematically showing an example of functions of the main server device 20A shown in FIG. 1.

FIG. 4B is a block diagram schematically showing an example of the functions of the video server device 20B shown in FIG. 1.

FIG. 5A is a flow chart showing an example of operations performed in the video distribution system 1 shown in FIG. 1.

FIG. 5B is a flow chart showing an example of operations performed in the video distribution system 1 shown in FIG. 1.

FIG. 6 is a schematic diagram showing an example of a virtual space displayed by a terminal device 10 included in the video distribution system 1 shown in FIG. 1.

FIG. 7 is a schematic diagram showing another example of a virtual space displayed by a terminal device 10 included in the video distribution system 1 shown in FIG. 1.

FIG. 8 is a schematic diagram showing an example of a public venue accommodated in a virtual space displayed by a terminal device 10 included in the video distribution system 1 shown in FIG. 1.

FIG. 9 is a schematic diagram conceptually showing an example of a range in which the playback position of a video displayed by each user’s terminal device 10 is changed, in the video distribution system 1 shown in FIG. 1.

FIG. 10 is a schematic diagram showing a partially enlarged example of a graph created by the server device 20 in the video distribution system 1 shown in FIG. 1.

### MODES TO IMPLEMENT

This specification is described in the sense of various representative embodiments, which are not intended to be limiting in any way.

As used in this application, singular forms such as “a,” “the,” “above-mentioned,” “said,” “aforementioned,” “this,” and “that” can include a plurality unless the lack of a plural is explicitly indicated. Also, the term “includes” can mean “having” or “comprising.” Further, the terms “coupled,” “joined” and “connected” encompass mechanical, electrical, magnetic and optical methods, as well as other methods, that bind, connect, or join objects to each other, and do not exclude the presence of intermediate elements between objects that are thus coupled, joined or connected.

The various systems, methods and devices described herein should not be construed as limiting in any way. In practice, this disclosure is directed to all novel features and aspects of each of the various disclosed embodiments, combinations of these various embodiments with each other, and combinations of portions of these various embodiments with each other. The various systems, methods, and devices described herein are not limited to any particular aspect, particular feature, or combination of such particular aspects and particular features, and the articles and methods described herein do not require that one or more particular effects exist or that any problem is solved. Moreover, various features or aspects of the various embodiments described herein, or portions of such features or aspects, may be used in combination with each other.

Although the operations of some of the various methods disclosed herein have been described in a particular order for convenience, the descriptions in such methods should be understood to include rearranging the order of the above operations unless a particular order is otherwise required by specific text below. For example, a plurality of operations described sequentially is in some cases rearranged or executed concurrently. Furthermore, for the purpose of simplicity, the attached drawings do not illustrate the various ways in which the various items and methods described herein can be used with other items and methods. Additionally, this specification may use terms such as “create,” “generate,” “display,” “receive,” “evaluate,” and “distribute.” These terms are high-level descriptions of the actual various operations executed. The actual various operations corresponding to these terms may vary depending on the particular implementation, and may be readily recognized by those of ordinary skill in the art having the benefit of the disclosure of this specification.

Any theories of operation, scientific principles or other theoretical statements presented herein in connection with the disclosed devices or methods are provided for better understanding and are not intended to limit the technical scope. The devices and methods in the appended scope of the claims are not limited to devices and methods that operate according to methods described by such theories of operation.

Any of the various methods disclosed herein can be implemented using a plurality of computer-executable commands stored on one or more computer-readable media (for example, non-transitory computer-readable storage media such as one or more optical media discs, a plurality of volatile memory components, or a plurality of non-volatile memory components), and can be executed on a computer. Here, the aforementioned plurality of volatile memory components includes, for example, DRAM or SRAM. Further, the aforementioned plurality of non-volatile memory components includes, for example, hard drives and solid-state drives (SSDs). Further, the aforementioned computer includes any computer available on the market, including, for example, smartphones and other mobile devices that have computing hardware.

Any of the aforementioned plurality of computer-executable commands for implementing the technology disclosed herein may be stored on one or more computer-readable media (for example, non-transitory computer-readable storage media) along with any data created and used during implementation of the various embodiments disclosed herein. Such a plurality of computer-executable commands may, for example, be part of a separate software application, or may be part of a software application that can be accessed or downloaded via a web browser or other software application (such as a remote computing application). Such software may be implemented, for example, on a single local computer (for example, as a process executed on any suitable computer available on the market) or in a network environment (for example, the Internet, a wide area network, a local area network, a client-server network (such as a cloud computing network), or other such network) using one or more network computers.

For clarity, only certain selected aspects of various software-based implementations are described. Other details that are well known in the art are omitted. For example, the technology disclosed herein is not limited to any particular computer language or program. For example, the technology disclosed herein may be implemented by software written in C, C++, Java, or any other suitable programming language. Similarly, the technology disclosed herein is not limited to any particular type of computer or hardware. Specific details of suitable computers and hardware are well known and need not be described in detail herein.

Further, any of the various such software-based embodiments (for example, including a plurality of computer-executable commands for causing a computer to execute any of the various methods disclosed herein) can be uploaded, downloaded, or accessed remotely by any suitable communication means. Such suitable communication means include, for example, the Internet, World Wide Web, an intranet, a software application, a cable (including a fiber optic cable), magnetic communications, electromagnetic communications (including RF communications, microwave communications, and infrared communications), electronic communications or other such communication means.

Various embodiments will be described below with reference to the attached drawings. The same reference numerals are attached to common components in the drawings. Also, it should be noted that components depicted in one drawing may be omitted in another drawing for convenience of explanation. Furthermore, it should be noted that the attached drawings are not necessarily drawn to accurate scale.

### 1. Configuration of Video Distribution System

In a video distribution system disclosed in this application, first, a terminal device of a user can display a virtual space (such as a movie theater) that accommodates a public venue (such as a screening room) for showing videos, based on operation data showing the content of an operation of the user. Further, the terminal device of the user displays an entry-allowed time slot that includes at least a show start time that is specified for the public venue to an end time obtained by adding an allowed time to the show start time. Furthermore, when a time at which the public venue is selected as a venue to be entered based on the operation data is included in the entry-allowed time slot, the terminal device of the user can receive a video specified for the public venue from a server device and display the video.

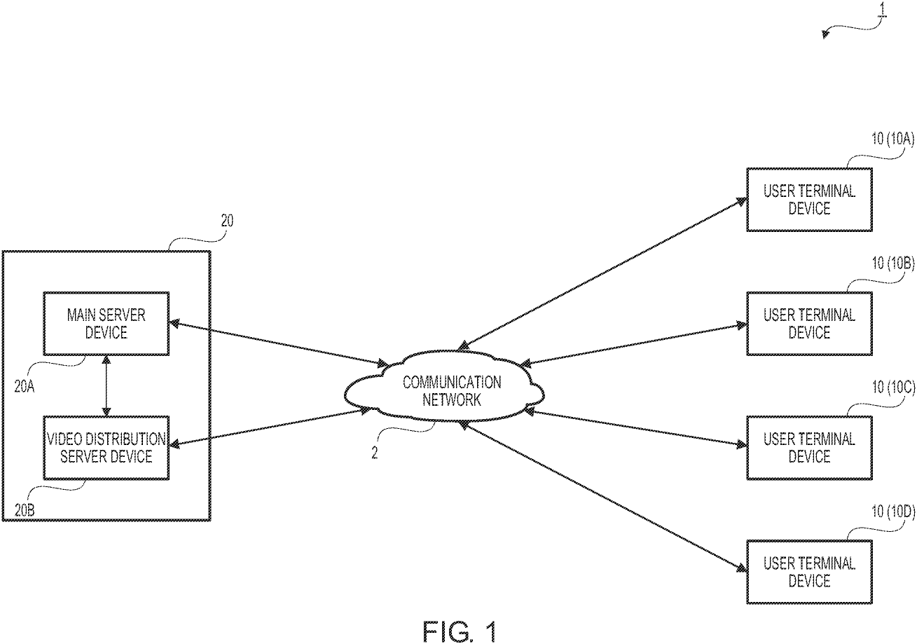

FIG. 1 is a block diagram showing an example of a configuration of a video distribution system according to one embodiment. As shown in FIG. 1, a video distribution system 1 can include a plurality of terminal devices 10 that can be connected to a communication line (communication network) 2, and at least one server device 20 that can be connected to the communication line 2. Each terminal device 10 can be connected to the at least one server device 20 through the communication line 2.

In FIG. 1, terminal devices 10A through 10D are shown as the plurality of terminal devices 10, but one or more other terminal devices 10 may be used in the same manner. Similarly, in FIG. 1, only one server device 20 is shown, but one or more other server devices 20 may be used in the same manner. The communication line 2 may include, but is not limited to, a mobile phone network, a wireless network, a landline telephone network, the Internet, an intranet, a local area network (LAN), a wide area network (WAN), and/or an Ethernet network. Here, the wireless network can include an RF connection(s) via, for example, Bluetooth, WiFi (such as IEEE 802.1 1a/b/n), WiMax, cellular, satellite, laser, and/or infrared.

### 1-1. Terminal Devices 10

Each terminal device 10 can execute an installed video viewing application (which may be middleware, or a combination of an application and middleware. The same applies below. By so doing, each terminal device 10 can, for example, by communicating with the server device 20, display (i) a virtual space that accommodates at least one public venue for showing a video and (ii) the at least one public venue, based on operation data that indicates content of an operation of that user. In addition, each terminal device 10 can receive, from the server device 20, a video corresponding to a public venue selected from among the at least one public venue based on the operation data, and display the video.

Each terminal device 10 can be any terminal device that can execute such operations, and may include, but is not limited to, a smartphone, tablet, a mobile phone (feature phone), and/or a personal computer, or the like.

### 1-2. Server Device 20

In FIG. 1, an example is shown in which the server device 20 includes a main server device 20A and a video distribution server device 20B, which are communicably connected to each other. The names “main server device” and “video distribution server device” are merely simple exemplary names, and any name can be used.

The main server device 20A can send image data related to, for example, each public venue and a virtual space to each terminal device 20. Through this, each terminal device 10 can display each public venue and the virtual space.

The video distribution server device 20B can store, for example, predetermined videos for each public venue. This video distribution server device 20B can distribute to the terminal device 20 a video corresponding to the public venue selected by the terminal device 20 from among the at least one public venue.

The server device 20 may include a main server device 20A and a video distribution server device 20B that are physically separated from each other and electrically connected to each other, in order to distribute loads and realize efficient processing. In other embodiments, the server device 20 can include a main server device 20A and a video distribution server device 20B that are physically integrated with each other.

### 2. Hardware Configuration of Each Device

Next, an example of a hardware configuration of each of the terminal device 10 and the server device 20 will be described.

### 2-1. Hardware Configuration of Terminal Devices 10

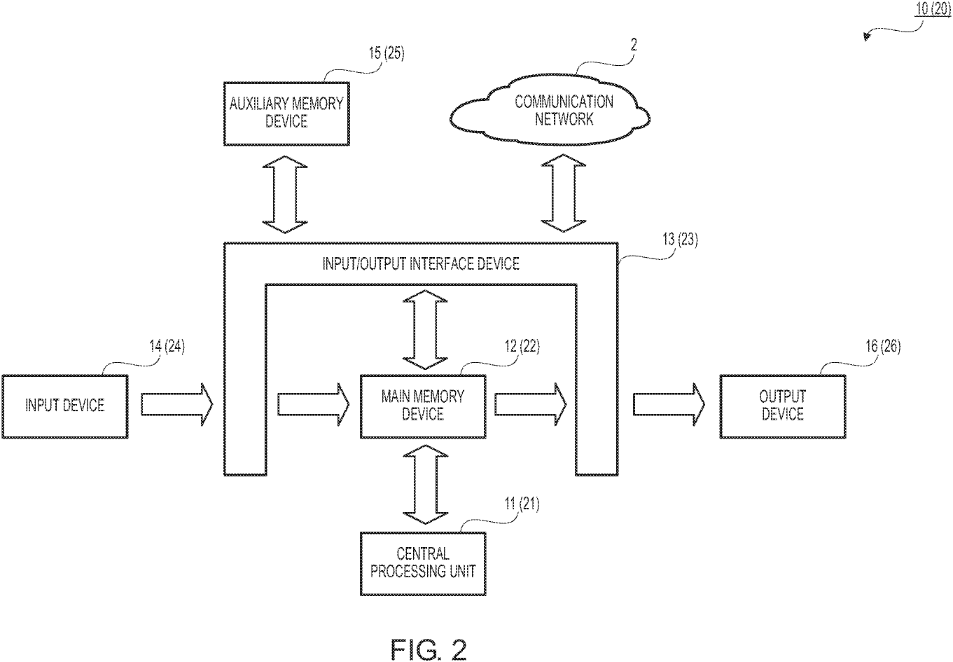

An example of a hardware configuration of each terminal device 10 will be described with reference to FIG. 2. FIG. 2 is a block diagram schematically showing an example of a hardware configuration of the terminal device 10 (server device 20) shown in FIG. 1. (In FIG. 2, the reference numerals in parentheses are described in relation to the server device 20 as will be described later.)

As shown in FIG. 2, each terminal device 10 can primarily include a central processing unit 11, a main memory device 12, an input/output interface device 13, an input device 14, an auxiliary memory device 15, and an output device 16. These devices are connected to each other by a data bus and/or a control bus.

The central processing unit 11 is called a “CPU,” can perform operations on commands and data stored in the main memory device 12, and can store the results of the operations in the main memory device 12. Further, the central processing unit 11 can control the input device 14, the auxiliary memory device 15, the output device 16, and the like through the input/output interface device 13. A terminal device 10 may include one or more such central processing units 11.

The main memory device 12 is called a “memory,” and can store commands and data received from the input device 14, the auxiliary memory device 15, and the communication line 30 (the server device 20 and the like) via the input/output interface device 13, as well as operation results from the central processing unit 11. The main memory device 12 can include, but is not limited to, computer-readable media such as volatile memory, non-volatile memory and storage (for example, a hard disk drive (HDD), a solid state drive (SSDs), a magnetic tape, and optical media). Here, the above-mentioned volatile memory includes, for example, a register, cache, and/or random access memory (RAM)). The above-mentioned non-volatile memory includes, for example, read-only memory (ROM), EEPROM, and/or flash memory. As will be readily understood, the term “computer-readable storage media” can include media for data storage such as memory and storage, rather than transmission media such as modulated data signals, that is, transient signals.

The auxiliary memory device 15 is a memory device that has a larger capacity than the main memory device 12. The auxiliary memory device 15 can store commands and data (computer programs) that constitute the above-described video viewing application, a web browser application, and the like. Furthermore, the auxiliary memory device 15 can send these commands and data (computer programs) to the main memory device 12 via the input/output interface device 13 under the control of the central processing unit 11. The auxiliary storage device 15 can include, but is not limited to, a magnetic disk device and/or an optical disk device, or the like.

The input device 14 is a device that takes in data from the outside, and can include, but is not limited to, a touch panel, buttons, a keyboard, a mouse and/or a sensor, or the like. The sensor may include, but is not limited to, a sensor including one or more cameras or the like, and/or one or more microphones or the like, as described below.

The output device 16 may include, but is not limited to, a display device, a touch panel, and/or a printer device, or the like.

In such a hardware configuration, the central processing unit 11 can sequentially load commands and data (computer programs) constituting a specific application stored in the auxiliary memory device 15 into the main memory device 12, and operate on the loaded commands and data. Thereby, the central processing unit 11 can control the output device 16 via the input/output interface device 13, or send and receive various data to and from other devices (for example, the server device 20 and/or other terminal devices 10) through the input/output interface device 13 and the communication line 2. These various data can include, but are not limited to, data related to evaluation data described hereafter and/or data related to a graph(s) described hereafter. Here, the data related to the evaluation data can include, for example, data that identifies a video, data that identifies the evaluation data, and data that identifies a playback position in the video at which the evaluation data is registered.

Accordingly, by executing the installed video viewing application or the like, the terminal device 10 of a user can execute at least one of the operations listed as examples below (including various operations described in detail hereafter), for example, without being limited thereto.
An operation of receiving image data related to a virtual space and each public venue accommodated in this virtual space from the server device 20 (for example, the main server device 20A)
   An operation that displays a virtual space based on (i) operation data that indicates content of an operation the user and/or (ii) movement data related to a movement of the user, using the received image data
   An operation of displaying each public venue based on the operation data and/or the movement data, using the received image data
An operation of displaying an avatar of the user in the virtual space based on the operation data and/or the movement data
An operation of displaying the avatar of the user at each public venue based on the operation data and/or the movement data
An operation of creating position data that indicates the position of the avatar of the user in the virtual space and/or each public venue based on the operation data and/or the movement data, and sending the position data to the server device 20 (for example, the main server device 20A)
An operation of receiving avatar data (avatar image data and/or avatar position data) related to another user’s avatar from the server device 20 (for example, the main server device 20A)
An operation of displaying the avatar of the other user in the virtual space based on the avatar data
An operation of displaying the avatar of the other user at each public venue based on the avatar data
An operation of receiving, from the server device 20 (for example, the main server device 20A), time slot data related to an entry-allowed time slot that includes at least a show start time that is specified for each public venue to an end time obtained by adding an allowed time to the show start time, and displaying the time slot data
An operation of receiving a message sent in a specific group to which the user belongs from the server device 20 (for example, the main server device 20A), and displaying the message
An operation of receiving, from the server device 20 (for example, the video distribution server device 20B), a video corresponding to one of the public venues selected from among the at least one public venue based on the operation data, and displaying the video

It should be noted that the terminal device 10 may include one or more microprocessors and/or a graphics processing unit (GPU), in place of or together with the central processing unit 11.

### 2-2. Hardware Configuration of Server Device 20

A hardware configuration example of each server device 20 will be described with reference to FIG. 2 in the same way. As the hardware configuration of each server device 20 (main server device 20A and video distribution server device 20B), for example, the same configuration as the hardware configuration of each terminal device 10 described above can be used. Therefore, the reference numerals for the components of each server device 20 are shown in parentheses in FIG. 2.

As shown in FIG. 2, each server device 20 can primarily include a central processing unit 21, a main memory device 22, an input/output interface device 23, an input device 24, an auxiliary memory device 25, and an output device 26. These devices are connected to each other by a data bus and/or a control bus.

The central processing unit 21, the main memory device 22, the input/output interface device 23, the input device 24, the auxiliary memory device 25, and the output device 26 can be substantially the same as the central processing unit 11, the main memory device 12, the input/output interface device 13, the input device 14, the auxiliary memory device 15, and the output device 16, respectively, included in each terminal device 10 described above.

In such a hardware configuration, the central processing unit 21 can sequentially load instructions and data (computer programs) that constitute a specific application (video distribution application or the like) stored in the auxiliary memory device 25 into the main memory device 22, and operate on the loaded commands and data. Thereby, the central processing unit 21 can control the output device 26 via the input/output interface device 23, or send and receive various data to and from other devices (for example, each terminal device 10 or the like) via the input/output interface device 23 and the communication line 2. These various data can include, but are not limited to, data related to evaluation data described hereafter (which can include, for example, data that identifies a video, data that identifies the evaluation data, and data that identifies a playback position in the video at which the evaluation data is registered) and/or data related to a graph(s) described hereafter.

Accordingly, the main server device 20A can execute at least one of the operations listed as examples below (including various operations described in detail hereafter), for example, without being limited thereto.
An operation of sending image data related to the virtual space and each public venue accommodated in this virtual space to each terminal device 10
An operation of distributing a message sent by the terminal device 10 of each user belonging to a specific group to the terminal device 10 of each user belonging to the specific group
An operation of receiving position data of the avatar of each user from the respective terminal devices 10
An operation of sending avatar data of another user (image data of the other avatar and/or position data of the other avatar) to the terminal device 10 of each user

Similarly, the video distribution server device 20B can execute at least one of the operations listed as examples below (including various operations described in detail hereafter), for example, without being limited thereto.
An operation of distributing to a terminal device 10 a video corresponding to a public venue selected by the terminal device 10 from among the at least one public venue.
An operation of controlling the playback position of a video corresponding to one of the public venues, when distributing this video to the terminal device 10 of each user belonging to a specific group created for that public venue.

It should be noted that the server device 20 may include one or more microprocessors and/or a graphics processing unit (GPU) instead of or in addition to the central processing unit 21.

### 3. Functions of Each Device

### 3-1. Functions of Terminal Devices 10

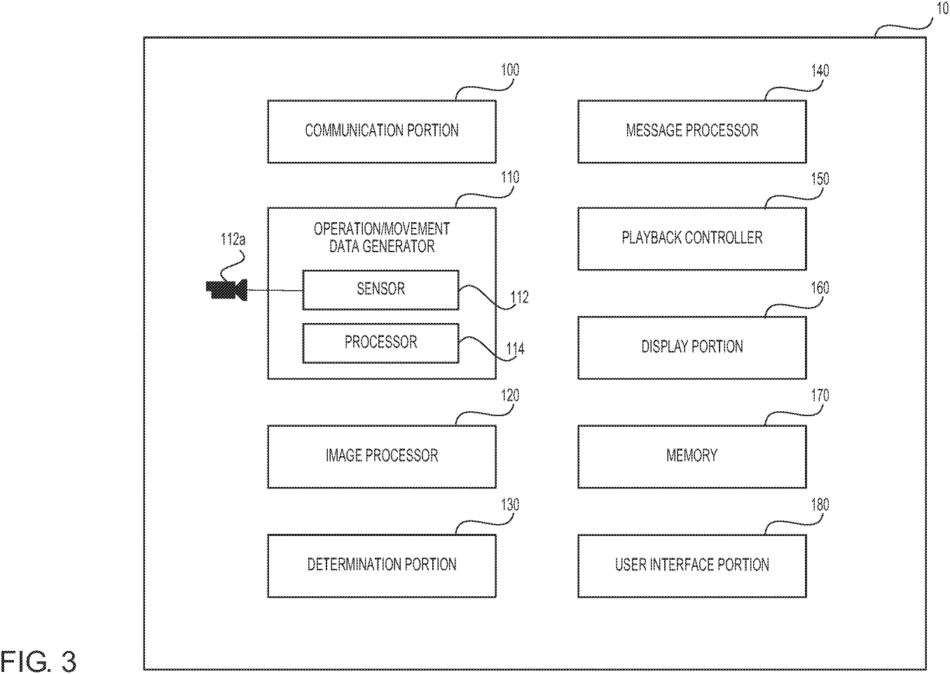

Next, an example of functions of the terminal devices 10 will be described with reference to FIG. 3. FIG. 3 is a block diagram showing an example of functions of each terminal device 10 shown in FIG. 1.

As shown in FIG. 3, the terminal device 10 includes a communication portion 100, an operation/movement data generator 110, an image processor 120, a determination portion 130, a message processor 140, a playback controller 150, a display portion 160, a memory 170, and a user interface portion 180.

### Communication Portion

The communication portion 100 can communicate various data used for viewing videos with the server device 20 (the main server device 20A and the video distribution server device 20B).

For example, the communication portion 100 can send or receive at least one of the following types of data, without being limited thereto.

### (Data Received by Communication Portion 100)

Image data related to a virtual venue accommodating at least one public venue, sent by the server device 20 (for example, the main server device 20A)
Image data related to each public venue, sent by the server device 20 (for example, the main server device 20A)
Avatar data (avatar image data and/or avatar position data) related to the avatar of another user, sent by the server device 20 (for example, the main server device 20A)
Time slot data related to an entry-allowed time slot that includes at least a show start time that is specified for each public venue to an end time obtained by adding an allowed time to the show start time, sent by the server device 20 (for example, the main server device 20A).
A video corresponding to one of the at least one public venue selected based on the operation data and sent by the server device 20 (for example, the video distribution server device 20B).
A message sent in a specific group to which the user of the terminal device 10 belongs, and sent by the server device 20 (for example, the main server device 20A)

### Data Sent by Communication Portion 100

Position data showing the position of the avatar of the user of the terminal device 10 in the virtual space and/or each public venue based on the operation data and/or the movement data, and being sent to the server device 20 (for example, the main server device 20A)
A message sent by the terminal device 10 to a specific group to which the user of the terminal device 10 belongs

### Operation/Movement Data Generator 110

The operation/movement data generator 110 can create operation data showing the content of an operation by the user and/or movement data related to movement of the user. The operation data may be data showing the content of an operation input by the user via the user interface portion 180. Such operation data can include, but is not limited to, tapping, dragging, and swiping on a touch panel, mouse input (clicking or the like), keyboard input, or the like.

The movement data may be data that records a digital representation of a movement of the user’s body (face or the like) in association with a time stamp. In order to create such movement data, the operation/movement data generator 110 uses, for example, a sensor 112 and a processor 114.

The sensor 112 may include one or more sensors 112a (for example, a camera 112a) that acquire data related to the user’s body.

The one or more sensors 112a can include, for example, a radiation portion (not shown) that radiates infrared rays toward the user’s face or the like, and an infrared camera (not shown) that detects infrared rays reflected from the distributor’s face or the like. Alternatively, the one or more sensors 112a can include an RGB camera (not shown) that photographs the distributor’s face or the like, and an image processor (not shown) that processes an image photographed by the camera.

Using data detected by the one or more sensors 112a, the processor 114 can detect a change in the user’s facial expression from a predetermined point in time (for example, the initial point in time at which detection is started), and a change in a relative position of the user. Thereby, the processor 114 can create movement data (motion data) that shows a change in the user’s face or the like in association with a time stamp. Such movement data is, for example, data that shows how a part of the user’s face or the like changed and how the relative position of the user changed, for each unit of time identified by the time stamp.

In other embodiments, for example, the movement data may be acquired using a motion capture system. As will be readily appreciated by those skilled in the art having the benefit of this disclosure, some examples of suitable motion capture systems that may be used with the devices and methods disclosed in the this application include optical motion capture systems that use passive or active markers, or do not use markers, and inertial and magnetic non-optical systems. Motion data can be acquired using an image capture device that is combined with a computer that changes motion data to video or other image data. Here, the image capture apparatus is a device such as a CCD (charge coupled device) or CMOS (complementary metal-oxide semiconductor image sensor).

### Image Processor 120

Using image data related to the virtual space received from the server device 20 (for example, the main server device 20A), the image processor 120 can draw a virtual space based on operation data and/or movement data created by the operation/movement data generator 110, and display the virtual space on the display portion 160. Specifically, first, the image processor 120 can create position data related to the position (3D coordinates) and orientation (0 degrees to 360 degrees orientation about the Z axis) of the avatar of the user of the terminal device 10 in a virtual space (for example, a movie theater, a live event house, or the like), based on the operation data and/or movement data created by the operation/movement data generator 110. For example, when the operation data and/or movement data show movement in a forward direction, the image processor 120 can create position data in which the y coordinate of the user’s avatar in the virtual space is increased. Alternatively, if the operation data and/or movement data show that the direction changes to the right (or left), the image processor 120 can create position data in which the orientation of the user’s avatar is rotated 90 degrees to the right (or left).

Further, the image processor 120 can read out image data corresponding to the position data (three-dimensional coordinates and orientation) of the user’s avatar from among the image data related to the virtual space and each public venue received from the server device (for example, the main server device 20A) and stored in the memory 170, and draw the virtual space or any of the public venues and display such on the display portion 160.

In this way, the image processor 120 can determine the three-dimensional coordinates and orientation of the user’s avatar in the virtual space based on the operation data and/or movement data, and draw and display the virtual space using the image data corresponding to the three-dimensional coordinates and orientation thus determined. At this time, the image processor 120 can draw and display an animation in which the user’s avatar is walking, in combination with the virtual space. Accordingly, the image processor 120 can create and display an image in which the user’s avatar moves inside the virtual space or inside each public venue based on the operation data and/or movement data.

The image processor 120, in one embodiment, can display the virtual space or each public venue in combination with the user’s avatar (from a third-person perspective). In other embodiments, the image processor 120 can display only the virtual space or each public venue (from a first-person perspective) without displaying the user’s avatar.

Furthermore, by the communication portion 100 periodically or intermittently receiving avatar data (avatar image data and/or avatar position data) related to another user’s avatar from the server device 20 (for example, the main server device 20A), the image processor 120 can display the virtual space or each public venue in combination with the other user’s avatar (from a first- or third-person perspective). Specifically, the avatar data related to the other user’s avatar indicates the three-dimensional coordinates and orientation of the other user’s avatar in the virtual space. By using such avatar data, the image processor 120 can arrange and display the other user’s avatar in the virtual space or each public venue at the position corresponding to the three-dimensional coordinates indicated by the avatar data, and in the orientation indicated by the avatar data.

### Determination Portion

The determination portion 130 can determine whether a time at which a public venue (for example, a screening room or a small live event room or stage) is selected by the terminal device 10 from among at least one public venue accommodated in a virtual space (for example, a movie theater, a live event house, or the like) is included in the entry-allowed time slot set for that public venue. Such a determination can be made, for example, by at least one method from among the following methods.
The determination portion 130 compares (i) the time at which one of the public venues is selected from among the at least one public venue based on operation data and/or movement data created by the operation/movement data generator 110 and (ii) the entry-allowed time slot set for that public venue.
The server device 20 (for example, the main server device 20A) performs the determination by comparing (i) the time at which one of the public venues is selected from among the at least one public venue based on operation data and/or movement data created by the operation/movement data generator 110 and (ii) the entry-allowed time slot set for that public venue. Based on the determination result received from the server device 20, the determination portion 130 can perform the determination.

### Message Processor 140

The message processor 140 can perform various processing related to messages sent in a specific group to which the user of the terminal device 10 belongs. For example, the message processor 140 can send a message input via the user interface portion 180 by the user of the terminal device 10 to the server device 20 (for example, the main server device 20A).

Further, the message processor 140 can display, on the display portion 160, a message sent in the specific group to which the user of the terminal device 10 belongs and received from the server device 20 (for example, the main server device 20A).

### Playback Controller 150

The playback controller 150 can perform control related to a playback position of a video sent by the server device 20 (video distribution server device 20B), which is a video corresponding to one of the public venues selected by the terminal device 10 from among the at least one public venue.

Specifically, the playback controller 150 can display an object (seek bar or the like) in combination with the video, which enables changing of the playback position of the video. Furthermore, when the position of the object is changed based on operation data, the playback controller 150 can play back the video from the playback position corresponding to that position. Here, if a video corresponding to such a playback position is stored in the memory 170, the playback controller 150 can read out the video from the memory 170 and display it on the display portion 160. On the other hand, if a video corresponding to such a playback position is not stored in the memory, the playback controller 150 can display, on the display portion 160, a video received from the server device (for example, the video distribution server device 20B) via the communication portion 100.

As will be described hereafter, the playback controller 150 does not change the position of the object to an arbitrary position based on operation data, but can, for example, change the position of the object to at least one of the following positions.
A position between (i) the initial playback position of the video and (ii) the earliest playback position among positions at which each of a plurality of users belonging to a specific group (to which the user of the terminal device 10 belongs) is playing back the video
A position between (i) the initial playback position of the video and (ii) the latest playback position of the video when the video starts on schedule at the public venue

### Display Portion 160

The display portion 160 can display various data used for viewing videos. For example, the display portion 160 can display images that are created by the image processor 120 (and temporarily stored in the memory 170), videos that are received from the server device 20 (for example, the video distribution server device 20B) via the communication portion 100, and the like.

### Memory 170

The memory 170 can store various data used for viewing videos.

### User Interface Portion 180

The user interface portion 170 can input various data used for viewing videos through user operations. The user interface portion 170 can include, but is not limited to, for example, a touch panel, a pointing device, a mouse, and/or a keyboard.

### 3-2. Functions of Server Device 20

### Functions of Main Server Device 20A

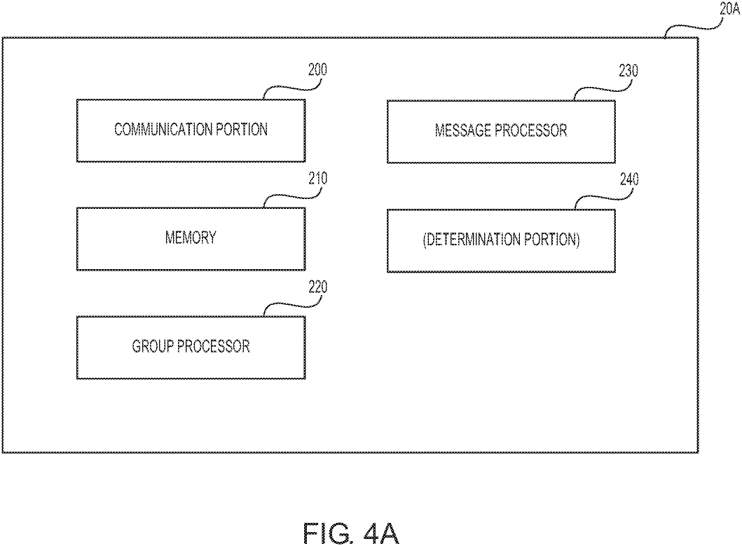

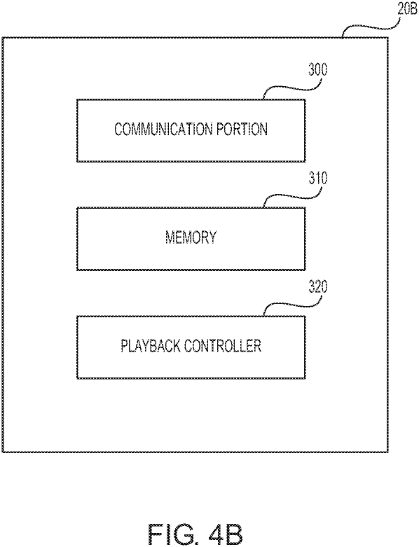

An example of the functions of the main server device 20A will be described with reference to FIG. 4A. FIG. 4A is a block diagram schematically showing an example of functions of the main server device 20A shown in FIG. 1.

As shown in FIG. 4A, the main server device 20A can include a communication portion 200, a memory 210, a group processor 220, and a message processor 230. Furthermore, the main server device 20A can also optionally include a determination portion 240.

The communication portion 200 can communicate various data used in relation to video distribution with the terminal device 10 of each user. The communication portion 200 can communicate at least one of the following data with the terminal device 10 of each user, without being limited thereto.

### Data Sent by Communication Portion 200

Image data related to the virtual space and to each public venue accommodated in the virtual space
Avatar data sent to a user’s terminal device 10, which is avatar data (avatar image data and/or avatar position data) related to the avatar of another user that is different from the data
Time slot data related to an entry-allowed time slot that includes at least a show start time that is specified for each public venue to an end time obtained by adding an allowed time to the show start time
A message sent by the terminal device 10 of each user belonging to a specific group

### Data Received by Communication Portion 200

A message sent by the terminal device 10 of each user belonging to a specific group
Data sent from each terminal device 10 and indicating one of the public venues selected by a terminal device 10 as a venue to be entered, from among at least one public venue

The memory 210 is used in relation to video distribution, and can store various data received from the communication portion 200.

The group processor 220 can perform various processing related to a plurality of groups created for each public venue. For example, the group processor 220 can create a plurality of groups for each public venue and manage which of these groups each user belongs to.

The message processor 230 performs processing that sends a message received from the terminal device 10 of a user to an entire specific group to which the user belongs, from among the plurality of groups managed by the group processor 220.

The determination portion 240 can perform the determination made by the determination portion 130 of the terminal device 10 described above, instead of or in parallel with the determination portion 130. Specifically, based on the operation data and/or the movement data created by the operation/movement data generator 110 of the terminal device 10, the determination portion 240 can perform the determination by comparing (i) a time at which a public venue is selected from among the at least one public venue and (ii) an entry-allowed time set for that public venue, and can send the result of the determination to the terminal device 10. In order to achieve this, the determination portion 240 needs to receive from the terminal device 10 data identifying the public venue selected as the venue to be entered and data identifying the time at which the public venue was selected.

### Functions of Video Distribution Server Device 20B

An example of the functions of the video distribution server device 20B will be described with reference to FIG. 4B. FIG. 4B is a block diagram schematically showing an example of the functions of the video server device 20B shown in FIG. 1.

As shown in FIG. 4B, the video distribution server device 20B can include a communication portion 300, a memory 310, and a playback controller 320.

The communication portion 300 can communicate various data used in relation to video distribution with the terminal device 10 of each user. The communication portion 300 can communicate at least one of the following data with the terminal device 10 of each user, without being limited thereto.

### Data Sent by Communication Portion 300

A video corresponding to a public venue selected by the terminal device 10 of the user as a venue to be entered from among the at least one public venue, the video being sent to the terminal device 10 of the user
Data relating to a playback position selectable by the terminal device 10 of the user for a video corresponding to a public venue selected by the terminal device 10 of the user as a venue to be entered from among the at least one public venue, the data being sent to the terminal device 10 of the user

### Data Received by Communication Portion 300

Data that identifies a video corresponding to a public venue selected by terminal device 10 of the user as a venue to be entered from among the at least one public venue, the data being received from the terminal device 10 of the user (the communication portion 300 can send the video identified by this data to the terminal device 10 of the user)
Data that identifies a current playback position of a video, that is sent from the terminal device 10 of each user receiving the video (by using this data, the playback controller 320 can recognize at which playback position the terminal device 10 of each user is playing back the video)
Data that identifies a playback position specified by the terminal device 10 of the user for a video corresponding to a public venue selected by the terminal device 10 of the user as a venue to be entered from among the at least one public venue, the data being received from the terminal device 10 of the user (from the playback position identified by this data, the playback controller 320 can send the video to the terminal device 10 of the user)

The memory 310 can store various data used in relation to video distribution and received from the communication portion 300.

The playback controller 320 can recognize at which playback position the terminal device 10 of each user is playing back a current video, using data that identifies the current playback position of the video received from the terminal device 10 of each user via the communication portion 300.

In addition, the playback controller 320 can control the playback position of the video in the terminal device 10 of each user that is receiving the video. Specifically, for example, the playback controller 320 can control the playback position of the video by the terminal device 10 of each user so that the video is played back at at least one playback position from among the following playback positions.
A position between (i) the initial playback position of the video and (ii) the earliest playback position among positions at which each of the plurality of users belonging to a specific group (to which the user of the terminal device 10 belongs) is respectively playing back the video
A position between (i) the initial playback position of the video and (ii) the latest playback position of the video when the video starts on schedule at the public venue

### 4. Operation of Video Distribution System 1

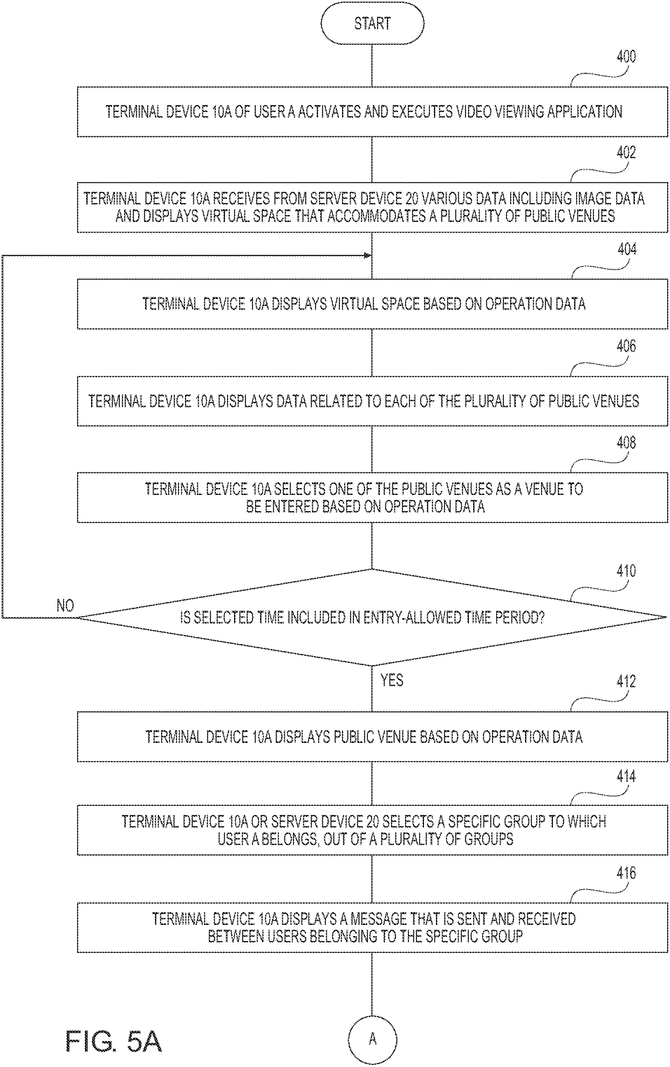

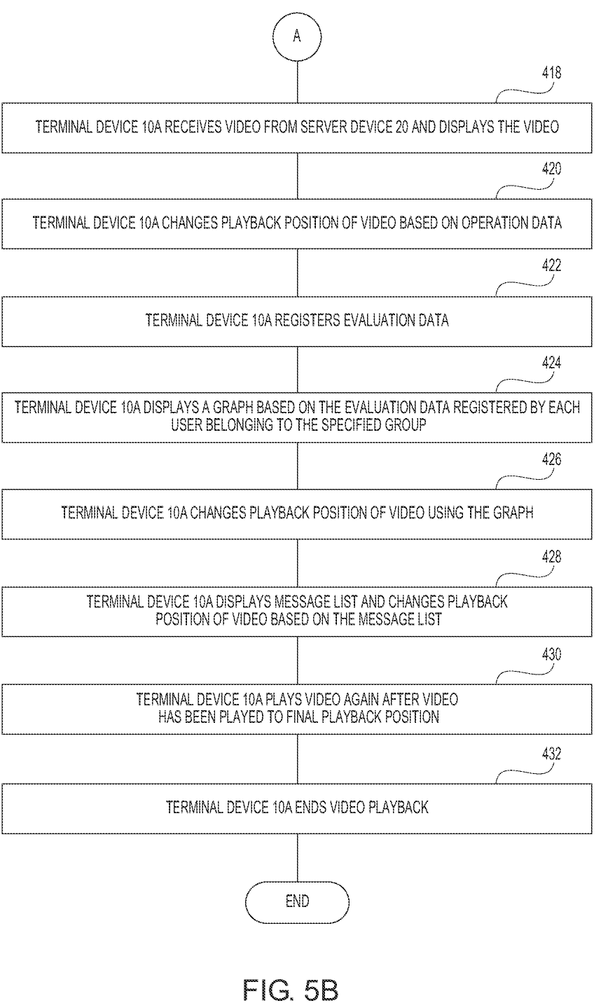

A specific example of operations performed in the video distribution system 1 that has the above-described configuration will be described with reference to FIGS. 5A and 5B. FIGS. 5A and 5B are a flow chart showing an example of operations performed in the video distribution system 1 shown in FIG. 1.

Referring to FIG. 5A, first, in step (hereinafter referred to as “ST”) 400, the terminal device 10A of a user (here, user A) can activate and execute a video viewing application.

Next, in ST402, the terminal device 10A can receive image data related to the virtual space and each public venue from the server device 20 (for example, the main server device 20A), and store the image data in the memory 170. Furthermore, the terminal device 10A can draw and display the virtual space and each public venue by using the received and stored image data.

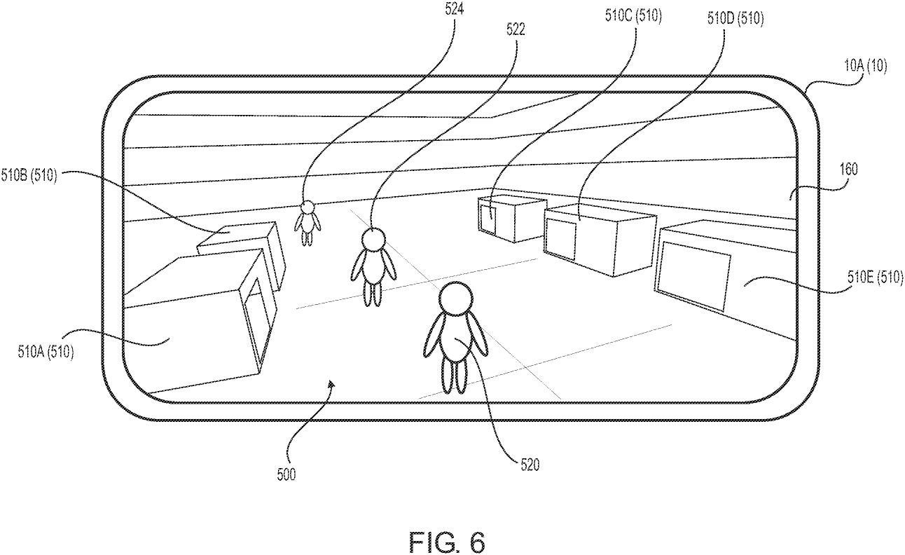

FIG. 6 is a schematic diagram showing an example of a virtual space displayed by a terminal device 10 included in the video distribution system 1 shown in FIG. 1. As shown in FIG. 6, a virtual space (here, a movie theater) 500 is displayed on the display portion 160 of the terminal device 10A. This virtual space 500 includes a plurality of public venues (here, screening rooms) 510 for showing videos. The plurality of public venues 510 can include, in this example, five public venues 510A-510E, for example. Furthermore, an avatar 520 of user A can be displayed in the virtual space 500 in combination with this space 500. The avatar 520 may also move and/or change according to operation data and/or movement data.

In the example shown in FIG. 6, the virtual space 500 is displayed in third-person perspective (TPS: Third Person Shooter). In other embodiments, the virtual space 500 can be displayed in first-person perspective (FPS: First Person Shooter). In this case, in the case of display in the first-person perspective, the avatar 520 of user A is not displayed.

Returning to FIG. 5A, in ST404, the terminal device 10A can display the virtual space based on operation data and/or movement data. Specifically, based on operation data and/or movement data that is created in response to user A tapping, clicking, or the like on the user interface portion 180, each time the position (three-dimensional coordinates) and/or orientation of the avatar 520 in the virtual space 500 changes, the terminal device 10A can read out image data related to the virtual space 500 and each public venue 510 corresponding to such positions and/or orientations from among the image data stored in the memory 170, and can draw and display the virtual space 500 and each public venue 510 by using the read image data.

In one embodiment, in ST402 described above, the terminal device 10A can collectively receive all image data related to the virtual space 500 and each public venue 510 from the server device 20 and store them in the memory 170. In other embodiments, it is also possible for the terminal device 10A to receive from the server device 20 only a part of the image data, among the image data related to the virtual space 500 and each public venue 510, and store the image data, and then, as needed (for example, when the position and/or orientation of the avatar 520 changes according to operation data and/or movement data), receive and store another portion(s) of the image data from the server device 20 again.

In addition, when the position and/or orientation of the avatar 520 of user A changes, the terminal device 10A can send position data related to the avatar 520 in the virtual space 500, that is, position data indicating the position (three-dimensional coordinates) and/or orientation (0 degrees to 360 degrees) of the avatar 520 to the server device 20 (main server device 20A). Alternatively, the terminal device 10A can send position data related to the avatar 520 to the server device 20 every arbitrary unit time (for example, 5 to 15 seconds). Thereby, the server device 20 can recognize the position and orientation of the user A in the virtual space 500.

Further, the server device 20 (main server device 20A) can similarly receive position data regarding other users’ avatars in the virtual space 500 from each of the other users’ terminal devices 10. Thereby, the server device 20 can recognize the position and orientation of each user’s avatar.

In this case, the server device 20 can also send the position data related to the other users’ avatars to the terminal device 10 of each user, for example, every arbitrary unit time. Thereby, the terminal device 10 of each user can recognize the positions and orientations of the other users’ avatars in the virtual space 500. As a result, the terminal device 10A of user A (similarly to other users) can draw and display each of the other users’ avatars 522, 524 in combination with the virtual space 500, as shown in FIG. 6.

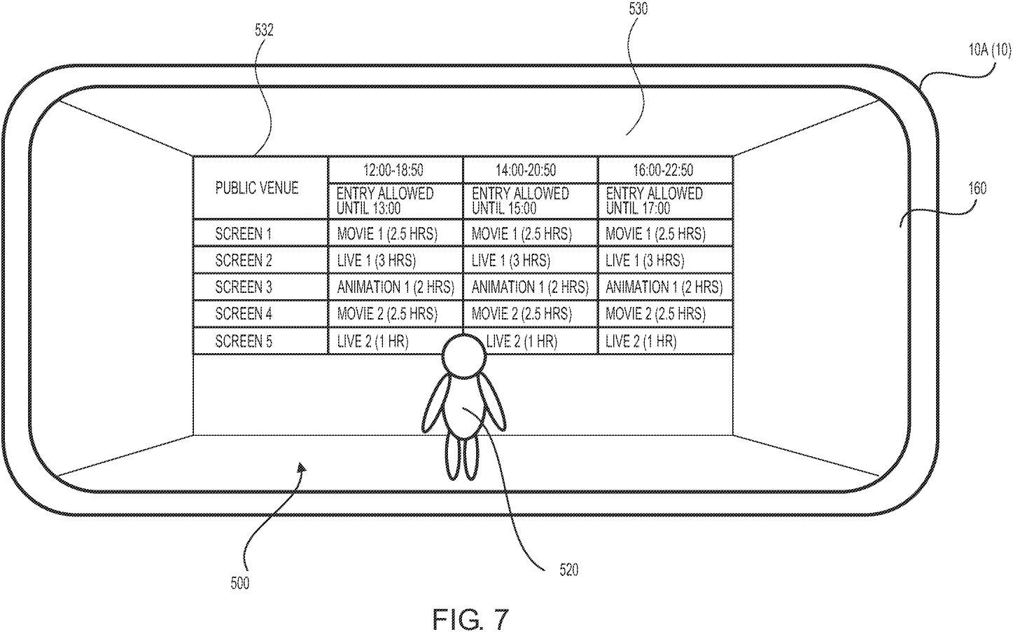

Returning to FIG. 5A, next, in ST406, the terminal device 10A can display data related to each of the plurality of public venues 510. FIG. 7 is a schematic diagram showing another example of a virtual space displayed by a terminal device 10 included in the video distribution system 1 shown in FIG. 1. In FIG. 7, an example is shown in which user A taps, clicks, or the like the front part of avatar 520, whereby the avatar 520 has moved forward in the virtual space 500 and reached the front of a reception counter 530. Data related to each public venue 510 is displayed on a display board 532 of the reception counter 530.

In the example shown in FIG. 7, the terminal device 10A, for each public venue 510, displays at least (i) a show start time (a time at which showing of the video is started) and (ii) an end time obtained by adding an allowed time to the show start time.

For example, for a public venue called Screen 1, the terminal device 10A can display (i) a show start time of “12:00” (the time at which the showing of “Movie 1” starts) and (ii) an end time of “13:00” (the latest time at which entry into this public venue is allowed) obtained by adding an allowed time (for example, 1 hour, but it can be set arbitrarily) to this show start time. That is, the terminal device 10A can display an entry-allowed time slot that includes at least the show start time (“12:00”) to the end time (13:00). In this case, each user can recognize that they can enter the public venue (“Screen 1”) at least during the time slot (entry-allowed time slot) from 12:00 to 13:00.

Although not shown in FIG. 7, if it is possible to enter the public venue at a time before the show start time, it is also possible for the terminal device 10A to display a front end time, which indicates from what time before the show start time entry is possible. In the example given above, the terminal device 10A can also display, as the front end time, for example, “11:30,” which is 30 minutes (can be set arbitrarily) before the show start time. In this case, each user can recognize that they can enter into the public venue (“Screen 1”) at least in the time slot (entry-allowed time slot) from 11:30 to 13:00.

Furthermore, as shown in FIG. 7, the terminal device 10A can also display a time (viewing end time) that indicates until what time each user who has entered the public venue can view the video in that public venue. In the example given above, the terminal device 10A displays that it is possible for each user that has entered the public venue (“Screen 1”) to view “Movie 1” until “18:50.”

Furthermore, as shown in FIG. 7, a plurality of entrance start times can be set for the public venue “Screen 1.” For example, for the public venue “Screen 1,” in addition to the above-described “12:00,” the show start times of “14:00” and “16:00” can be set. Similarly, for each of these show start times, the end time (and further, the front end time and viewing end time) can be displayed.

Here, the public venue “Screen 1” has been described as an example, but this explanation also applies to each of the public venues “Screen 2” to “Screen 5”.

In FIG. 7, an example is shown in which, for example, three show start times (“12:00,” “14:00,” and “16:00”) are set for the same public venue “Screen 1.” A user who has entered “Screen 1” with a show start time of “12:00” cannot enter “Screen 1” with a show start time of “14:00” or “16:00” at the same time. Therefore, although these three public venues are named “Screen 1,” they can be regarded as mutually different public venues. Therefore, it can be said that a plurality of public venues are distinguished from each other not just from the standpoint of virtual locations (names), but also from the standpoint of show start times.

Returning to FIG. 5A, in ST408, user A selects one venue from among the public venues displayed in ST406 as a venue to be entered. For example, in the example shown in FIG. 7, user A can select a venue to be entered from among 15 public venues (= 5 public venues × 3 show start times), by tapping or the like the name of one of the videos.

Alternatively, it is also possible for user A to cause the avatar 520 to walk around the virtual space 500 illustrated in FIG. 6, and select a desired public venue as a venue to be entered by causing the avatar 520 to move to the entrance of that public venue. Public venues 510A to 510E illustrated in FIG. 6 can correspond respectively to “Screen 1” to “Screen 5” illustrated in FIG. 7. In one embodiment, if the current time is within the range of “11:30” to “13:00,” user A can select the public venue specified by “Screen 1” and the show start time (“12:00”) by moving the avatar 520 to the entrance of the public venue 510A. Similarly, if the current time is in the range of “13:30” to “14:00,” user A can select the public venue specified by “Screen 2” and the show start time (“14:00”) by moving the avatar 520 to the entrance of the public venue 510B.

In one embodiment, a number-of-people limit can be set for each public venue. When the total number of users who have entered the public venue reaches the number-of-people limit, no user can enter the public venue thereafter. In the example illustrated in FIG. 7, the number-of-people limit can be displayed in association with each public venue. Thus setting a number-of-people limit for each public venue means setting a limit on the number of terminal devices 10 simultaneously connected to the server device 20 in order to view a video shown at the public venue. Thereby, the server device 20 can control the communication load on the server device 20.

Returning to FIG. 5A, in ST410, the terminal device 10A can determine whether the time at which user A selected a public venue to be entered in ST408 is included in the entry-allowed time slot corresponding to that public venue. In other embodiments, the terminal device 10A can cause the server device 20 to perform the above-described determination by sending, to the server device 20 (for example, the main server device 20A), (i) data that identifies the public venue selected by user A and (ii) data that identifies the time at which the public venue was selected by user A. In this case, by receiving data indicating the determination result from the server device 20, the terminal device 10A can determine whether the time at which the public venue to be entered was selected is included in the entry-allowed time slot corresponding to that public venue.

If the terminal device 10A or the server device 20 determines that the time at which the public venue to be entered was selected is not included in the entry-allowed time slot corresponding to that public venue, the process returns to ST404 described above (or a return to ST402 is also acceptable).

On the other hand, if the terminal device 10A or the server device 20 determines that the time at which the public venue to be entered was selected is included in the entry-allowed time slot corresponding to that public venue, the process moves to ST412.

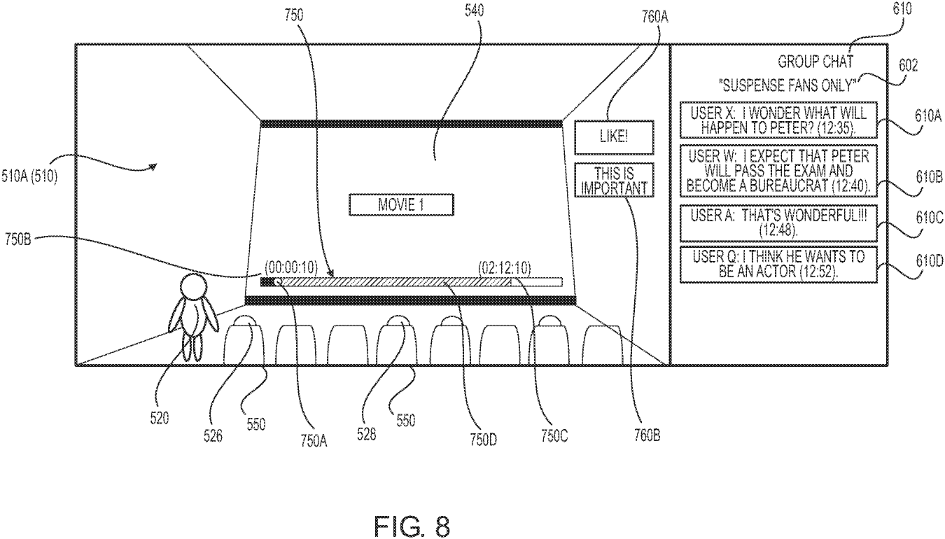

In ST412, the terminal device 10A can draw and display the interior of the public venue selected in ST408. FIG. 8 is a schematic diagram showing an example of a public venue accommodated in a virtual space displayed by the terminal device 10 included in the video distribution system 1 shown in FIG. 1. FIG. 8 shows an example in which the interior of “Screen 1” illustrated in FIG. 7 is displayed.

As shown in FIG. 8, the terminal device 10A can display the interior of the public venue 510A from a third-person perspective. The terminal device 10A can change the position and/or orientation of the avatar 520 and display the avatar 520 based on operation data and/or movement data. In other embodiments, the terminal device 10A can also display the public venue 510A from a first-person perspective in which the avatar 520 is not displayed.

In addition, when a seat for each user to be seated is specified, when user A is seated in the designated seat, the terminal device 10A can display the interior of the public venue 510A from the viewpoint from that seat from a third-person perspective or a first-person perspective. In this case, as the interior of the public venue 510A, the terminal device 10A can display a screen area 540 and an area between the screen area 540 and the seats (including avatars of other users, and seats of the avatars). Thereby, user A can have the experience of being in an actual movie theater.

As shown in FIG. 8, the terminal device 10A can also display the avatars 526, 528, and the like of other users who have entered the public venue 510A as if they were sitting on seats 550, for example. This can be realized by the terminal device 10A receiving position data related to the other users’ avatars from the server device 20, for example at every unit time, as described with reference to FIG. 6.

Returning to FIG. 5A, next, in ST414, the terminal device 10A or the server device 20 can select a group (specific group) to which the user A should belong from among a plurality of groups created for the public venue into which user A has entered.

In a first example, for each public venue, the server device 20 (for example, the main server device 20A) can cause a new group for users who have entered the public venue to belong to to be created via the user interface portion 180 of a terminal device 10, together with a name, title or theme (hereinafter referred to as “name or the like”) of the new group. For example, a user who has entered the public venue can create a group with a name such as “Suspense Fans Only,” and belong to the group, via the user interface portion 180 of the user’s terminal device 10. In order to realize this, the server device 20 can, for each public venue, associate (i) data identifying a group, (ii) data identifying the name or the like of the group, and (iii) data identifying the users belonging to the group, and can store and manage the associated data.

In this first example, consider a case in which a plurality of groups has already been created by a plurality of users. In this case, the server device 20 can present, to the terminal device 10A of user A, the above-described plurality of groups that has already been created for the public venue that user A has entered, and allow user A to select which group to belong to. By selecting one of the groups from among the above-described plurality of groups through the user interface 180 of the terminal device 10A, user A can belong to that group (specific group).

In a second example, the server device 20 (for example, the main server device 20A) can create a plurality of groups, each of which is assigned an entry time slot, for each public venue. For example, for a public venue specified by “Screen 1” and a show start time (“12:00”), the server device 20 can create a plurality of groups, Group 1, Group 2, Group 3, and Group 4, that correspond respectively to time slots at which that public venue was entered, that is, time slot 1 (for example, “11:30” to “11:44”), time slot 2 (for example, “11:45” to “11:59”), time slot 3 (for example, “12:00” to “12:14”), and time slot 4 (for example, “12:15” to “12:29”). In order to realize this, the server device 20 can, for each public venue, associate (i) data identifying a group, (ii) data identifying a time slot assigned to the group, and (iii) data identifying the users belonging to the group, and can store and manage the associated data.

In this second example, when user A has entered the public venue specified by “Screen 1” and the show start time (“12:00”), and when the time of entering the public venue is, for example, 11:46, the terminal device 10A of user A can display that the group (specific group) to which user A should belong is the group corresponding to time slot 2. The terminal device 10A or the server device 20 can determine to which group user A belongs. When the terminal device 10A makes such a determination, the terminal device 10A needs to receive and acquire, from the server device 20, the data stored by the server device 20 as described above regarding the public venue into which user A has entered. When the server device 20 makes such a determination, the terminal device 10A needs to send, to the server device 20, data identifying the public venue into which the user A entered and data identifying the time at which the user A entered the public venue.

In a third example, for each public venue, the server device 20 (for example, the main server device 20A) can create a plurality of groups, each of which is assigned at least one attribute. For example, the server device 20 can create Group 1 to which attribute 1 is assigned, Group 2 to which attribute 2 is assigned, Group 3 to which attribute 3 is assigned, Group 4 to which attribute 4 is assigned, and the like. The attribute assigned to each group may be one attribute or a plurality of attributes. Each attribute can be selected from a group including age, gender, favorite genre, occupation, address, domicile, blood type, zodiac sign, personality, and the like.

To realize this, the server device 20 can, for each public venue, associate (i) data identifying a group, (ii) data identifying at least one attribute assigned to the group, and (iii) data identifying the users belonging to the group, and can store and manage the associated data. In addition, the server device 20 can register at least one attribute in advance for each user.

In this third example, when user A has entered the public venue specified by “Screen 1” and the show start time (“12:00”), a group corresponding to (matching) at least one attribute registered by the terminal device 10A or the server device 20 for the user A, among the plurality of groups, can be selected as the group (specific group) to which user A belongs. The terminal device 10A or the server device 20 can determine to which group user A belongs. When the terminal device 10A makes such a determination, the terminal device 10A needs to receive and acquire the data stored by the server device 20 as described above regarding the public venue into which the user A has entered. When the server device 20 makes such a determination, the terminal device 10A needs to send, to the server device 20, data identifying the public venue into which the user A has entered (and also, as needed, data identifying the attribute that is registered for user A).

In this way, when a group (specific group) to which user A should belong is selected, for example, an object 602 corresponding to “Suspense Fans Only,” which is the name or the like of the specific group, may be displayed as illustrated in FIG. 8.

Returning to FIG. 5A, next, in ST416, for the specific group selected in ST414 as the group to which user A should belong, each time a message is sent from the terminal device 10 of any user belonging to this specific group, the terminal device 10A can receive the message from the server device 20 (for example, the main server device 20A) and display the message. In addition, the terminal device 10A can also send a message input by user A via the user interface portion 180 to the server device 20. In this case, this message can be sent by the server device 20 to the terminal devices 10 of the users belonging to the specific group (including the terminal device 10A of the user A). In this way, each user belonging to the specific group exchanges messages with each other in real time, and thereby can achieve communication regarding videos (contents) to be shown at the public venue into which the user has entered, along with the progress of the videos, that is, communication can be achieved while sharing the same content.

In this application, the term “real-time method” means that when a user’s terminal device 10 sends a message to the server device 20, the message is sent from the server device 20 to each terminal device 10 without intentionally causing a substantial delay, except for delays and faults or the like that occur on the communication line 2, delays and faults or the like that occur in processing by the server device 20 and/or the terminal devices 10, and the like. In such a real-time method, every time a message is sent from the terminal device 10 of a user who has already entered a public venue, the message is sent by the server device 20 not only to the terminal device 10 of each user who has already entered the venue, but also to the terminal device 10 of a new user who, for example, entered the public venue right at that timing. In other words, the latest message can always be sent by the server device 20 not only to the terminal devices of users who have already entered the public venue, but also to the terminal devices 10 of new users who entered the public venue later than those users. This is because real-time communication is emphasized among all users who have entered the public venue.

As illustrated in FIG. 8, messages sent by each of users X, W, A, and Q belonging to the specific group “Suspense Fans Only” are sent via the server device 20 to the terminal device 10 of each user belonging to this specific group, together with the sending times of the messages, for example. As a result, as illustrated in FIG. 8, messages 610A to 610D sent respectively by users X, W, A, and Q can be displayed sequentially from top to bottom in chronological order, for example, in a chat area 610 on the terminal device 10A of user A, in combination with their sending times.

Next, referring to FIG. 5B, in ST418, the terminal device 10A of user A can receive from the server device 20 (for example, the video distribution server device 20B) a video (“Movie 1”) specified for the public venue into which user A has entered, and display the video. Here, the main server device 20A sends (i) data identifying user A and (ii) data identifying the public venue into which user A has entered (and data identifying the time at which user A entered the public venue, if necessary) to the video distribution server device 20B, whereby the video distribution server device 20B can distribute the video (“Movie 1”) determined for the public venue to the terminal device 10A of user A.

In one embodiment, the server device 20 (for example, the video distribution server device 20B) can distribute the video to the terminal device 10A of the user A by streaming from an initial playback position (0 hours 00 minutes 00 seconds). Thereby, the terminal device 10A can play back and display the video from the initial playback position. The terminal device 10A can, for example, as illustrated in FIG. 8, display the video in a screen area 540 arranged in a central portion of the public venue 510A. In addition, the terminal device 10A can also display the video in a full-screen manner according to an operation by user A via the user interface portion 180, for example. Even in this case, the chat area 610 may still be displayed.

Returning to FIG. 5B, next, in ST420, the terminal device 10A can also change the playback position of the video based on operation data. Specifically, when each user belonging to the specific group can play back a video from an arbitrary playback position, because the playback position of each user belonging to the specific group by the terminal devices 10 varies widely among the users, it can be difficult for each user belonging to the specific group to substantially share the same video along the progression of the video. Therefore, in one embodiment, each user belonging to the specific group can change the playback position of the video within the following range.

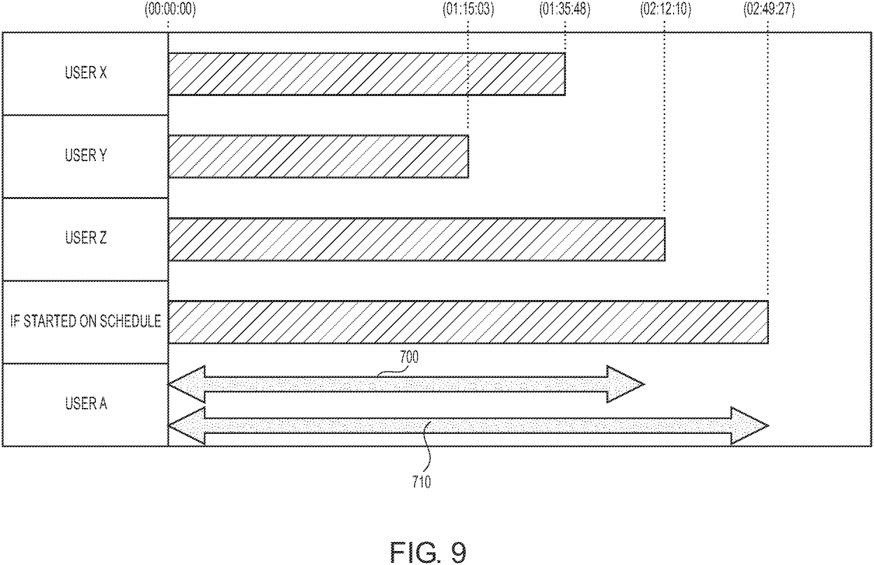

FIG. 9 is a schematic diagram conceptually showing an example of a range in which the playback position of a video displayed by each user’s terminal device 10 is changed, in the video distribution system 1 shown in FIG. 1. In FIG. 9, to simplify the explanation, an example is shown in which the users belonging to a specific group are the four users X, Y, Z, and A.

In FIG. 9, for each of users X, Y, and Z, the current playback position of the same video (“Movie 1”) is shown. For example, the current playback positions for users X, Y, and Z are (1 hour 35 minutes 48 seconds), (1 hour 15 minutes 3 seconds), and (2 hours 12 minutes 10 seconds), respectively. Since user A has just entered this public venue 510A, the current playback position of user A is assumed to be the initial playback position (0 hours 00 minutes 10 seconds).

In a first example, the terminal device 10 of each user (and also the terminal device 10A of user A) can change between (i) an initial playback position and (ii) the earliest playback position among the positions at which this video is being played back respectively for each of the plurality of users belonging to the specific group. In the example shown in FIG. 9, the earliest playback position among the plurality of users is the playback position of user Z (2 hours 12 minutes 10 seconds). Therefore, the terminal device 10 of each user (and also the terminal device 10A of user A) can change the playback position of this video in the range 700 between (0 hours, 0 minutes, 0 seconds) and (2 hours, 12 minutes, 10 seconds). As a result, none of the users can independently change the playback position of this video to a playback position earlier than (2 hours, 12 minutes, 10 seconds).

In order to realize this, the terminal device 10 of each user can send the current playback position of the video to the server device 20 (for example, the video distribution server device 20) every arbitrary unit time. Thereby, the server device 20 can, for all the users belonging to the specific group, identify the current playback position of the video and, by extension, the earliest playback position in this specific group. The server device 20 can communicate the earliest playback position in the specific group to the terminal device of each user belonging to the specific group, every arbitrary unit time. As a result, the terminal device 10 of each user can change the playback position of video between the initial playback position and the earliest playback position communicated from the server device 20 every unit time.

In a second example, the terminal device 10 of each user (and also the terminal device 10A of user A), can change the playback position of the video between (i) the initial playback position and (ii) the latest playback position of the video when the playback of the video started as scheduled at this public venue 510A at the show start time. In the example shown in FIG. 9, the latest playback position of the video is (2 hours 49 minutes 27 seconds) when playback of the video started on schedule at the show start time (12:00). Therefore, the terminal device 10 of each user (and also the terminal device 10A of user A) can change the playback position of this video in the range 710 between (0 hours, 0 minutes, 0 seconds) and (2 hours, 49 minutes, 27 seconds). As a result, none of the users can independently change the playback position of this video to a playback position earlier than (2 hours, 49 minutes, 27 seconds).

In order to realize this, the server device 20 (for example, the video distribution server device 20B) can acquire and store the latest playback position of the video set for the public venue 510A when this video is started at the scheduled show start time. Since the server device 20 (video distribution server device 20B) is responsible for distributing videos, it can always recognize the latest playback position. Furthermore, the server device 20 can communicate the latest playback position to the terminal device of each user belonging to the specific group every arbitrary unit time. As a result, each user’s terminal device 10 can change the playback position of this video between (i) the initial playback position and (ii) the latest playback position communicated from the server device 20 every unit time.

In both the first example and the second example described above, as illustrated in FIG. 8, the terminal device 10A of user A can display a seek bar function 750, which changes the playback position of the video. This seek bar function 750 includes, for example, (i) an object 750A arranged at the current playback position in the playback time slot of the entire video, (ii) characters (“00:00:10”) 750B indicating the current playback position of the video, and (iii) characters (“02:12:10”) 750C indicating the earliest playback position (in the case of the first example described above) or characters (“02:49:27”) 750C indicating the latest playback position (in the case of the second example described above). In addition, the seek bar function 750 can further include an object 750D that indicates a changeable area extending between (i) the current playback position of the video and (ii) the earliest playback position (in the case of the first example above) or the latest playback position. Here, the terminal device 10A can display the characters 750C (“02:12:10”) indicating the earliest playback position (in the case of the first example described above) or the characters (“02:49:27”) 750C indicating the latest playback position (in the case of the second example described above), and the object 750D that indicates the changeable area, by using the earliest playback position (in the case of the first example described above) or the latest playback position (in the case of the second example described above) communicated from the server device 20 every unit time.

User A can change the position of the object 750A in the range between (00:00:00) and (02:12:10) via the user interface portion 180, thereby changing the playback position of the video. Accordingly, the terminal device 10A can change the playback position of the video based on operation data created via the user interface portion 180. The characters (“02:12:10”) 750C indicating the earliest playback position (in the case of the first example) or the characters (“02:49:27”) 750C indicating the latest playback position (in the case of the second example), and the object 750D indicating the changeable area, change with the elapse of time.

User A can also temporarily stop the playback of the video by tapping or the like an object (for example, object 750A) via the user interface portion 180.

Returning to FIG. 5B, next, in ST422, user A of the terminal device 10A can register at least one evaluation data for the video being viewed, in association with the playback position of the video. The at least one evaluation data is data indicating an evaluation relating to a specific playback position of the video, and can include, but is not limited to, evaluation data such as “like,” “this is important,” “watch this carefully,” and/or “best.”

When a playback position arrives that user A wants to evaluate, user A can register such evaluation data in association with the playback position by selecting an object displayed by terminal device 10A via the user interface portion 180. As illustrated in FIG. 8, for example, user A can, for example, when a playback position arrives that user A wants to evaluate, tap or the like the “like” button 760A or the “this is important” button 760B. In response, the terminal device 10A can send, for example, (i) data identifying the video, (ii) data identifying the evaluation data, and (iii) data identifying a playback position in the video at which the evaluation data is registered to the server device 20 (for example, the video distribution server device 20B). Thereby, the server device 20 can register (store) the evaluation data in association with the playback position for the video.

By the same method, the server device 20 can receive, from the terminal device 10 of each user belonging to the specific group (to which user A belongs), (i) data identifying a video, (ii) data identifying evaluation data, and (iii) data identifying a playback position in the video for which the evaluation data is registered, and store this data. Using this data, the server device 20 can create a graph that associates the evaluation data with the playback position of the video.

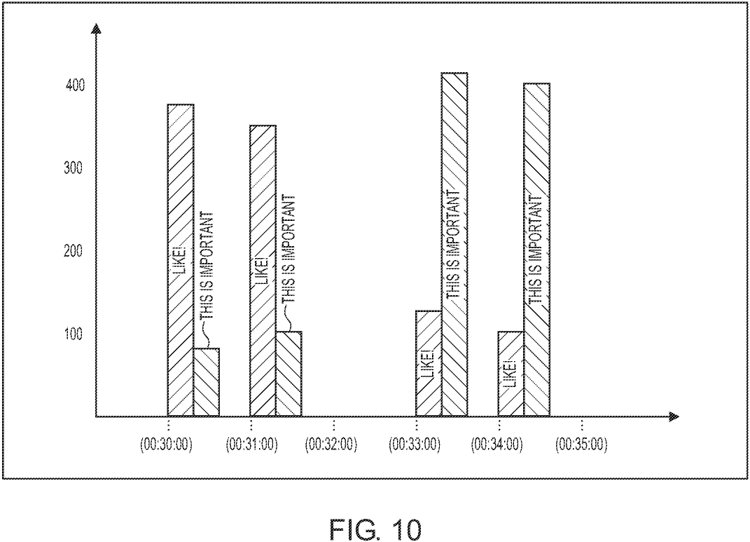

FIG. 10 is a schematic diagram showing a “partially” enlarged example of a graph created by the server device 20 in the video distribution system 1 shown in FIG. 1. The graph shown in FIG. 10 can, for example, show the total number of first evaluation data (here, “likes”) and the total number of second evaluation data (here, “this is important”) registered for every unit time slot (here, a one-minute time slot). The server device 20 can create the graph illustrated in FIG. 10 for every unit time slot by calculating the total number of first evaluation data and the total number of second evaluation data registered by all users belonging to the specific group. In addition, in FIG. 10, the total numbers of each evaluation data for each unit time slot of one minute (one mode of playback position), as an example, are displayed. The unit time slot (playback position) may be selected from a group including 1 second, 5 seconds, 10 seconds, 30 seconds, 50 seconds, 1 minute, 2 minutes, 5 minutes, 10 minutes, 15 minutes, and the like.

The server device 20 can create or update such a graph for each arbitrary unit time, and send the created or updated graph to the terminal device 10 of each user belonging to the specific group.

Returning to FIG. 5B, next, in ST424, the terminal device 10A of user A can display (or not display) graphs received from the server device 20 for each unit time, in combination with the screen area 540 (and the chat area 610) shown in FIG. 8. Thereby, user A can, while recognizing that this playback position (30 minutes to 32 minutes) of the video is a portion that was favorably evaluated by many users belonging to the specific group, watch that portion of the video more carefully. In addition, user A can, while recognizing that this playback position (33 minutes to 35 minutes) of the video is a portion that drew the attention of many users belonging to the specific group, watch that portion of the video more carefully.

Next, in ST426, user A pays attention to the fact that this playback position (30 minutes to 31 minutes) of the video is a portion that has been favorably evaluated (evaluated as exciting) by particularly many users, and taps or the like a vertically extending bar at this playback position that indicates the total number of first evaluations, or characters indicating this playback position (00:30:00), whereby the terminal device 10A can play back and display this video from this playback position.

Similarly, user A pays attention to the fact that this playback position (33 minutes to 34 minutes) of the video is a portion that has been favorably evaluated (evaluated as important) by particularly many users, and taps or the like a vertically extending bar at this playback position that indicates the total number of second evaluations, or characters indicating this playback position (00:33:00), whereby the terminal device 10A can play back and display this video from this playback position.

Next, in ST428, the terminal device 10A of the user A can, at every arbitrary unit of time, for example, create and update a message list in which (i) messages sent to the specific group by user A and (ii) times (that is, the playback positions in the video) at which the messages were sent are recorded in association each other. Once the terminal device 10A has created such a message list, it can display (or not display) the message list in combination with the screen area 540 (and the chat area 610) illustrated in FIG. 8. By browsing such a message list, user A can recognize what kind of message was sent to the specific group at which playback position of the video. Furthermore, if there is a noteworthy message among the messages sent by the user A, the terminal device 10 can, by user A tapping or the like that message or the playback position displayed in association with that message, go back to this playback position at which user A sent the message and play back and display the video.

The terminal device 10A can send (data related to) the message list created in this way to the server device 20, and cause it to be stored, for the purpose of, for example, using the message list when viewing the same video again later or the like. The terminal device 10A can receive (data relating to) the message list stored in the server device 20 in this way from the server device 20 by making a request to the server device 20, and display the message list.

Next, in ST430, the terminal device 10A can stop the playback of the video by playing back the video to its final playback position. After this, user A is allowed to use the terminal device 10A to view the same video again until a prescribed period of time has elapsed. This prescribed period of time ends here at 18:50, for example, as described in connection with FIG. 7.

Specifically, for example, “Movie 1” that is shown at the public venue selected by user A is 2.5 hours of content. When user A starts watching “Movie 1” on schedule at the show start time and does not stop the playback even once, this “Movie 1” ends at 14:30. Nevertheless, user A can watch this “Movie 1” again until 18:50.

The reason why the video can be viewed again within such a prescribed period of time is to ensure that after user A enters this public venue, even if the video becomes unable to be viewed due to various reasons including, but not limited to, failure of the terminal device 10A, deterioration of the communication environment, or the like, user A can reliably finish completely watching the same video.

Finally, in ST432, the terminal device 10A of user A can end the playback of the video.

Although operations performed between the terminal device 10A of user A and the server device 20 have been described above as examples, the same operations can also be performed between the terminal devices 10 of other users and the server device 20.

In addition, in order to simplify the explanation, ST416 to ST430 have been described as being performed in this order. However, it should be understood that, in reality, at least a portion of the operations of ST416 to ST430 may be performed repeatedly in parallel with each other or in any order with respect to each other. It should also be noted that at least a portion of the operations of ST416-ST430 may not be performed.

Furthermore, in the various embodiments described above, the case was described in which a plurality of public venues is accommodated in a virtual space. However, it is also possible to have only one public venue accommodated in a virtual space.

In addition, in the example shown in FIG. 7, the case was described in which the showing of videos progresses in the same cycle for every unit time (two hours in FIG. 7) in a plurality of public venues. That is, the case was described in which, at the public venue called “Screen 1,” the showings of the video start at “12:00,” “14:00,” and “16:00,” respectively, and similarly, at the public venue “Screen 2” as well, the showings of the video start at “12:00,” “14:00,” and “16:00,” respectively. However, it is also possible for the videos to be shown at separate cycles for each of a plurality of public venues.

As described above, in the technology disclosed in this application, for a public venue accommodated in a virtual space, an entry-allowed time slot can be set that includes at least a show start time to an end time obtained by adding an allowed time to the show start time. A video specified for this public venue can be shown only to users who have entered this public venue (selected this public venue) at a time included in this entry-allowed time slot. As a result, it can be ensured, to a certain degree, that at least a plurality of users out of all the users who have entered the public venue view the video substantially at the same timing (including a substantially same timing in a broad sense that includes a certain degree of variation) while providing a degree of freedom for all users who have entered the public venue in terms of the time at which they start watching the video.

In addition, a plurality of users who has entered one public venue is further divided into a plurality of groups, and messages are allowed to be exchanged only among a plurality of users belonging to the same group while watching the video. As a result, a plurality of users having common interests and/or attributes can enjoy the same video while exchanging messages. Furthermore, by limiting the number of users who exchange messages in this manner, the users can easily and smoothly communicate with each other. Furthermore, it is possible to suppress, to some extent, the inconvenience of the ending of the video being communicated to a user who has just started watching the video, or to a user who has not finished watching the video, by the sending of a message that mentions the ending of the video by a user who has already finished watching the video.

### 5. Additional Modified Examples

### Modified Example 1

In the various embodiments described above, it was described that the terminal device 10A or the server device 20 can select a group (specific group) to which a user (for example, user A) should belong, from among a plurality of groups created for a public venue into which user A has entered.

In this case, the terminal device 10A or the server device 20 can form a sub group, in the same specific group, for a plurality of users who entered the public venue at close times. The server device 20 can start distributing a video at the same time (that is, at the same show start time) to the plurality of users belonging to this sub group. Thereby, the plurality of users belonging to the small group can be provided with the shared experience of viewing the same video together with other users belonging to the small group at the same time, while still having the flexibility to freely select the time at which to start viewing the video.

As a method to form such a small group, for example, at least one of methods (A) to (C) listed as examples below can be used, without being limited thereto. Also, it is also possible to combine a plurality of methods among the methods (A) to (C).

(A) The server device 20 forms a plurality of sub time slots at regular time intervals (for example, every 10 minutes) from a certain time (for example, a front end time, a show start time, or the like), and a plurality of users who have entered a public venue in the same sub time slot are formed into a sub group. For example, when the front end time is “9:00,” a plurality of users who have entered the public venue during a first sub time slot “9:00 to 9:10” can be formed into a first sub group, and a plurality of users who have entered the public venue during a second sub time slot of “9:11 to 9:21” can be formed into a second sub group.

The server device 20 can start the distribution of a video to (the terminal devices 10 of) the plurality of users belonging to each sub group at the same time. For example, in the examples described above, the server apparatus 20 can start the distribution of the video at “9:15” for the first sub group, and can start the distribution of the video at “9:26” for the second sub group.

(B) The server device 20 can form a plurality of users (including a certain user), who have entered the public venue within a fixed period of time (for example, 10 minutes) from the time when the certain user entered the public venue, into a sub group. Thereafter, the server device 20 can form a plurality of users (including a separate user), who have entered the public venue within a fixed period of time (for example, 10 minutes) from the time when the separate user entered the public venue, into a separate sub group.

In this case as well, the server device 20 can start distribution of a video to (the terminal devices 10 of) a plurality of users belonging to each sub group at the same time.

(C) The server device 20 can form a fixed number of users into a sub group in response to the fact that the total number of users who have entered the public venue has reached the fixed number (for example, 10 people). Thereafter, the server device 20 can form a fixed number of users into a separate sub group in response to the fact that the total number of users who have newly entered the public venue has reached the fixed number (for example, 10 people).

In this case as well, the server device 20 can start distribution of a video to (the terminal devices 10 of) a plurality of users belonging to each sub group at the same time.

When at least one of the above-described methods (A) to (C) is used, in addition, a plurality of users having at least one attribute in common can also be formed into a sub group. In this case, the server device 20 can, in advance, allocate and store at least one attribute for each user. Here, as the at least one attribute, it is possible to use “(I) an attribute based on each evaluation data and/or each message, and the information of the user who posted them” described in (2) “Modified Example 2” below.

### Modified Example 2

In the various embodiments described above, it was described that the terminal device 10A displays a graph created or updated by the server device 20, and that the terminal device 10A displays a message list.

In this case, the terminal device 10A of the user (for example, user A) can set at least one attribute of user A in advance in response to an operation by user A. Thereafter, when user A enters a public venue and watches a video, in response to one of the at least one attribute that has been set in advance as described above being selected, the terminal device 10A can collectively display, or collectively not display, evaluation data corresponding to the thus-selected attribute, from among a plurality of evaluation data included in the above-described graph (see FIG. 10). Alternatively or in addition to this, when user A enters the public venue and watches the video, in response to one of the at least one attribute that has been set in advance as described above being selected, the terminal device 10A can collectively display, or collectively not display, a message corresponding to the thus-selected attribute, from among a plurality of messages included in the above-described message list.

In order to realize this, the server device 20 can assign at least one attribute to each of the plurality of evaluation data included in the created or updated graph, and send information related to the thus-assigned at least one attribute to the terminal device 10A at a predetermined timing, together with the graph. Such attribute assignment can be performed by the server device 20 using (i) information included in a search table (such as a search table that associates the type of evaluation data and at least one attribute) created in advance, (ii) information created by a learning model that is based on machine learning, and/or (iii) information input by an operator, or the like.

Further, the terminal device 10A can collectively display or not display evaluation data to which is assigned an attribute(s) that is the same as or similar to the at least one attribute selected by user A from among the plurality of evaluation data included in the graph that has been thus received.

Similarly, the server device 20 can assign at least one attribute to each of a plurality of messages included in the created or updated message list, and send information related to the thus-assigned at least one attribute to the terminal device 10A at a predetermined timing, together with the message list. Such attribute assignment can also be performed by the server device 20 using (i) information included in a search table (such as a search table that associates key words included in messages and at least one attribute) created in advance, (ii) information created by a learning model that is based on machine learning, and/or (iii) information input by an operator, or the like.

Furthermore, the terminal device 10A can collectively display or not display messages to which are assigned an attribute(s) that is the same as or similar to the at least one attribute selected by user A from among the plurality of messages included in the message list that has been thus received.

As the at least one attribute assigned to each evaluation data included in the graph and/or assigned to each message included in the message list (that is, at least one attribute displayed as an option on the display portion 160 by the terminal device 10A), for example, at least one attribute that is based on the information listed as examples below can be used, without being limited thereto.

(I) Attributes based on each evaluation data and/or each message, and information of the user who posted them
(IA) Interests of the posting user (field of interest set by the posting user, field of interest determined indirectly from the content of the posting user’s viewed videos and/or posted evaluation data and/or messages, or the like)
(IB) Classification of evaluation data and/or message (whether the classification touches on the content of the video, whether it is a mere impression or chat, whether the content is inappropriate (attacks on others, violence, or the like), or the like)
(IC) User’s basic information (age, gender, blood type, occupation, area of residence, nationality, domicile, birthplace, hobby, field of expertise, or the like)

If user A has selected at least one attribute among these attributes as a target for display (or a target for non-display) for evaluation data, from among a plurality of attributes included in a pull-down menu or the like displayed on the display portion 160 of the terminal device 10A, for example, all of the evaluation data to which is assigned the at least one attribute thus selected from among the plurality of evaluation data included in the graph can be collectively displayed (or not displayed). Similarly, if user A has selected at least one attribute among these attributes as a target for display (or a target for non-display) for a message, from among a plurality of attributes included in a pull-down menu or the like displayed on the display portion 160 of the terminal device 10A, for example, all of the messages to which are assigned the at least one attribute thus selected from among the plurality of messages included in the message list can be collectively displayed (or not displayed).

As a result, when user A enters a public venue and watches a video, the terminal device 10A can be caused to collectively display (or collectively not display) only evaluation data and/or messages that match (or do not match) user A’s preferences.

(II) Attributes based on time information
(IIA) The time in the video at which the evaluation data or the message was registered in the video
(IIB) In which time slot among the time slots of the video was the evaluation data or message registered?
(IIC) In which time slot among the time slots in the user’s real world was the evaluation data or message registered?

Regarding the above-described (IIA), if user A selects a non-display mode in which evaluation data registered at or after the current position (current time) of the video being viewed is not displayed (or a display mode in which such evaluation data is displayed) via an object or the like displayed on the display portion 160, the terminal device 10A can collectively place evaluation data to which are assigned the attribute (IIA) at or after the current position (current time) of the video being played back by the terminal device 10A, among a plurality of evaluation data included in the graph, in a non-display state (or can display such evaluation data). Similarly, if user A selects a non-display mode in which messages registered at or after the current position (current time) of the video being viewed are not displayed (or a display mode in which such messages are displayed) via an object or the like displayed on the display portion 160, the terminal device 10A can collectively place messages to which are assigned the attribute (IIA) at or after the current position (current time) of the video being played back by the terminal device 10A, among a plurality of messages included in the message list, in a non-display state (or can display such messages).

Regarding the above-described (IIB), if user A selects the non-display mode (or the display mode), the terminal device 10A can collectively place evaluation data to which are assigned the attribute (IIB) that includes the current position (current time) of the video being played back by the terminal device 10A, among a plurality of evaluation data included in the graph, in a non-display state (or can display such evaluation data). Similarly, if user A sets the non-display mode (or the display mode), the terminal device 10A can collectively place messages to which are assigned the attribute (IIB) that includes at or after the current position (current time) of the video being played back by the terminal device 10A, among a plurality of messages included in the message list, in a non-display state (or can display such messages).

Regarding the above-described (IIC), if user A selects the non-display mode (or the display mode), the terminal device 10A can collectively place evaluation data to which are assigned the attribute (IIC) that includes a time in the real world at which the video is being played back by the terminal device 10A, among a plurality of evaluation data included in the graph, in a non-display state (or can display such evaluation data). Similarly, if user A sets the non-display mode (or the display mode), the terminal device 10A can collectively place messages to which are assigned the attribute (IIC) that includes a time in the real world at which the video is being played back by the terminal device 10A, among a plurality of messages included in the message list, in a non-display state (or can display such messages).

As a result, the user A can cause evaluation data or messages that are based on desired/undesired time information to be displayed/not displayed. For example, in the above-described (IIB), if user A does not want to see prior information, user A selects the non-display mode to watch the video without seeing the prior information (that is, while avoiding so-called spoilers). If it is acceptable to see the prior information, user A can watch the video while seeing the prior information, by selecting the display mode.

(III) Attributes based on numerical information
(IIIA) Evaluation data or messages posted by the same user who has posted N times or more within a predetermined period within the video (where N is an arbitrary natural number).
(IIIB) Evaluation data or messages when the total number of such evaluation data or messages posted by one or more users within a predetermined period in the video is M (where M is an arbitrary natural number)

If user A selects at least one attribute from among these attributes, from among a plurality of attributes included in a pull-down menu or the like displayed on the display portion 160 of the terminal device 10A, for example, as a target for display (or a target for non-display), all of the evaluation data to which are assigned the at least one attribute selected in this way, among the plurality of evaluation data included in the graph, can be collectively displayed (or not displayed). Similarly, if user A selects at least one attribute from among these attributes, from among a plurality of attributes included in a pull-down menu or the like displayed on the display portion 160 of the terminal device 10A, for example, as a target for display (or a target for non-display), all of the messages to which are assigned the at least one attribute selected in this way, among the plurality of messages included in the message list, can be collectively displayed (or not displayed).

As a result, user A can cause evaluation data and/or messages that interfere with watching the video or that are posted during a time slot in which the user’s behavior is active to be collectively placed in a non-display state (or to be displayed).

As will be readily appreciated by a person of ordinary skill in the art having the benefit of this disclosure, the various examples described above may be used with each other in suitable combinations in various patterns, to the extent that no inconsistency is created.

Given the many possible embodiments in which the principles of the this specification may be applied, it should be understood that the various illustrated embodiments are merely various preferred examples and that the technical scope of the disclosure related to the scope of the claims should not be considered to be limited to these various preferred examples. In practice, the technical scope of the invention related to the scope of the claims is determined by the scope of the claims appended hereto. Therefore, the grant of a patent is requested for everything that falls within the technical scope described in the scope of the claims, as the disclosure of the inventors.

### 6. Various Aspects

A computer program according to a first aspect can, “by being executed by at least one processor, causes the at least one processor to perform the following functions:
displaying, based on operation data indicating content of an operation of a user, a virtual space that accommodates a public venue for showing a video;
displaying an entry-allowed time slot that includes at least (i) a show start time that is specified for the public venue to (ii) an end time obtained by adding an allowed time to the show start time;
determining whether a time at which the public venue was selected based on the operation data as a venue to be entered is included in the entry-allowed time slot of the public venue; and
when it is determined that the time at which the public venue is selected is included in the entry-allowed time slot, receiving a video specified for the public venue from a server device and displaying the video.”

A computer program according to a second aspect can, in the above-described first aspect, “cause the at least one processor to further perform the following function:

receiving the video from the server device and playing back the video from an initial playback position.”

A computer program according to a third aspect can, in the above-described second aspect, “cause the at least one processor to further perform the following function:

displaying a message sent and received between the user and another user who belongs to a specific group among a plurality of groups created for the public venue.”

A computer program according to a fourth aspect can, in the above-described third aspect, be such that:
“the specific group is at least one of the following:
   a group selected by the user from among a plurality of groups, each of which is created by one of the users;
   a group to which is assigned an entry time slot corresponding to a time when the user entered the public venue, from among a plurality of groups each assigned an entry time slot; and
   a group to which is assigned attribute data corresponding to attribute data registered for the user, from among a plurality of groups each assigned attribute data.”

A computer program according to a fifth aspect can, in the above-described fourth aspect, “cause the at least one processor to further perform the following function:

displaying an object that changes a playback position of the video for the user between (i) the initial playback position and (ii) an earliest playback position among positions at which each of the plurality of users belonging to the specific group is playing back the video.”

A computer program according to a sixth aspect can, in the above-described fourth aspect, “cause the at least one processor to further perform the following function:

displaying an object to change a playback position of the video for the user between (i) the initial playback position and (ii) a latest playback position of the video when the playback of the video starts on schedule at the show start time at the public venue.”

A computer program according to a seventh aspect can, in any of the above-described third aspect through the above-described sixth aspect, “cause the at least one processor to further perform the following function:

displaying the message in a real-time method without synchronizing the message with the playback of the video.”

A computer program according to an eighth aspect can, in any of the above-described second aspect through the above-described seventh aspect, “cause the at least one processor to further perform the following functions:
registering evaluation data selected, based on the operation data, from among at least one evaluation data indicating an evaluation of the video in association with a playback position of the video that can be registered by at least one of a plurality of users including the user and other users; and
displaying a graph created in association with the playback position of the video by using the at least one evaluation data registered by the at least one user.”

A computer program according to a ninth aspect can, in the above-described eighth aspect, “cause the at least one processor to further perform the following functions:
causing the graph to display a total number of the at least one evaluation data registered for the playback position in association with each of a plurality of playback positions, and
playing back the video from the playback position corresponding to one total number selected based on the operation data from among the total numbers included in the graph.”

A computer program according to a tenth aspect can, in any of the above-described second aspect through the above-described ninth aspect, “cause the at least one processor to further perform the following functions:
displaying a message list in which at least one message sent by the user is registered in association with a playback position of the video; and
playing back the video from the playback position corresponding to one message selected, based on the operation data, from among the at least one message included in the message list.”

A computer program according to an eleventh aspect can, in any of the above-described first aspect through the above-described tenth aspect, “cause the at least one processor to further perform the following function:

allowing the video to play back until a fixed period of time has elapsed from a time when the video was played back to a final playback position.”

A computer program according a twelfth aspect can, in any of the above-described first aspect through the above-described eleventh aspect, “cause the at least one processor to further perform the following function:

displaying an avatar of the user in the virtual space based on the operation data.”

A computer program according to a thirteenth aspect can, in any of the above-described first aspect through the above-described eleventh aspect, “cause the at least one processor to further perform the following function:

displaying an avatar of the user at the public venue based on the operation data when it is determined that the selected time is included in the entry-allowed time slot.”

A computer program according to a fourteenth aspect can, in any of the above-described first aspect through the above-described thirteenth aspect, “cause the at least one processor to further perform the following function:

displaying the entry-allowed time slot including (i) a front end time before the show start time determined for the public venue to (ii) the end time.”

A computer program according to a fifteenth aspect can, in the above-described first aspect, “cause the at least one processor to further perform the following functions:
displaying, based on the operation data, the virtual space accommodating a plurality of public venues for showing videos;
displaying, with respect to at least one of the plurality of public venues, an entry-allowed time slot that includes at least from (i) a show start time that is specified for the at least one public venue to (ii) an end time obtained by adding an allowed time to the show start time;
determining whether a time at which one public venue is selected from among the at least one public venue based on the operation data is included in the entry-allowed time slot of the one public venue; and
when it is determined that the time at which the one public venue is selected is within the entry-allowed time slot, receiving a video from the server device and displaying the video.”

A computer program according a sixteenth aspect can, in the above-described fifteenth aspect, be such that:
“the plurality of public venues includes at least a first public venue, a second public venue, and a third public venue;
(i) a time interval between the show start time specified for the first public venue and the show start time specified for the second public venue and (ii) a time interval between the show start time specified for the second public venue and the show start time specified for the third public venue are identical; and
the one public venue is one of the first public venue, the second public venue, and the third public venue.”

A computer program according to a seventeenth aspect can, in any of the above-described first aspect through the above-described sixteenth aspect, be such that:

“the at least one processor includes a central processing unit (CPU), a microprocessor and/or a graphics processing unit (GPU).”

A computer program according to an eighteenth aspect can, in any of the above-described first aspect through the above-described seventeenth aspect, “cause the at least one processor to further perform the following function:

receiving, from the server device via a communication line, data related to the entry-allowed time slot.”

A method according to a nineteenth aspect can be “a method executed by at least one processor that executes computer-readable commands, the method comprising, by the at least one processor executing the commands:
displaying, based on operation data indicating content of an operation of a user, a virtual space that accommodates a public venue for showing a video;
displaying an entry-allowed time slot that includes at least (i) a show start time that is specified for the public venue to (ii) an end time obtained by adding an allowed time to the show start time;
determining whether a time at which the public venue is selected based on the operation data as a venue to be entered is included in the entry-allowed time slot of the public venue; and
when it is determined that the time at which the public venue is selected is included in the entry-allowed time slot, receiving a video specified for the public venue from a server device and displaying the video.”

A method according to a twentieth aspect can, in the above-described nineteenth aspect, be such that:

“the at least one processor includes a central processing unit (CPU), a microprocessor and/or a graphics processing unit (GPU).”

A method according to a twenty-first aspect can, in the above-described nineteenth aspect or the above-described twentieth aspect, “further comprise:

receiving, from the server device via a communication line, data relating to the entry-allowed time slot.”

A method according to a twenty-second aspect can be “a method executed by at least one processor that executes computer-readable commands, the method comprising, by the at least one processor executing the commands:
sending, to a terminal device of a user, data related to an entry-allowed time slot that includes at least (i) a show start time that is specified for a public venue, accommodated in a virtual space, for showing a video to (ii) an end time obtained by adding an allowed time to the show start time;
determining whether a time at which the public venue was selected by the terminal device as a venue to be entered is included in the entry-allowed time slot of the public venue; and
when it is determined that the time at which the public venue was selected is included in the entry-allowed time slot, sending, to the terminal device, a video specified for the public venue.”

A method according to a twenty-third aspect can, in the above-described twenty-second aspect, be such that:

“the at least one processor includes a central processing unit (CPU), a microprocessor and/or a graphics processing unit (GPU).”

A method according a twenty-fourth aspect can, in the above-described twenty-second aspect or the above-described twenty-third aspect, “further comprise:

sending, to the terminal device via a communication line, data related to the entry-allowed time slot.”

A server device according a twenty-fifth aspect can “be provided with at least one processor, the at least one processor being configured to perform the following functions:
sending, to a terminal device of a user, data relating to an entry-allowed time slot that includes at least (i) a show start time that is specified for a public venue, accommodated in a virtual space, for showing a video to (ii) an end time obtained by adding an allowed time to the show start time;
determining whether a time at which the public venue was selected by the terminal device as a venue to be entered is included in the entry-allowed time slot of the public venue; and
when it is determined that the time at which the public venue was selected is included in the entry-allowed time slot, sending, to the terminal device, a video specified for the public venue. ”

A server device according a twenty-sixth aspect can, in the above-described twenty-fifth aspect, be such that:

“the at least one processor includes a central processing unit (CPU), a microprocessor and/or a graphics processing unit (GPU).”

A server device according to a twenty-seventh aspect can, in the above-described twenty-fifth aspect or the above-described twenty-sixth aspect, be such that:

“the at least one processor is further configured to send, to the terminal device via a communication line, data related to the entry-allowed time slot.”

As described above, according to various aspects, there are provided computer programs, methods, and server devices for distributing videos to a user’s terminal device by improved methods.

Explanation of Symbols

| | | |
|---|---|---|
| 1 | video distribution system | |
| 2 | communication line (communication network) | |
| 10, 10A to 10D | | terminal devices |
| 20 | server device | |
| 20A | main server device | |
| 20B | video distribution server device | |
| 100 | communication portion | |
| 110 | operation/movement data generator | |
| 120 | image processor | |
| 130 | determination portion | |
| 140 | message processor | |
| 150 | playback controller | |
| 160 | display portion | |
| 170 | memory | |
| 180 | user interface portion | |
| 200 | communication portion | |
| 210 | memory | |
| 220 | group processor | |
| 230 | message processor | |
| 240 | determination portion | |

1. A non-transitory computer-readable medium storing thereon a computer program that, by being executed by at least one processor, causes the at least one processor to perform the following functions:
displaying, based on operation data indicating content of an operation of a user, a virtual space that accommodates a virtual public venue for showing a video;
displaying an entry-allowed time slot that includes at least (i) a show start time that is specified for the public venue and (ii) an entry end time obtained by adding an allowed time to the show start time;
determining whether a time at which the public venue was selected based on the operation data as a venue to be entered is included in the entry-allowed time slot of the public venue; and
in response to determining that the time at which the public venue is selected is included in the entry-allowed time slot, receiving a video specified for the public venue from a server device and displaying the video.

2. The non-transitory computer-readable medium according to claim 1, wherein
the entry end time is different from an end time of the video displayed for the selected public venue.

3. The non-transitory computer-readable medium according to claim 1, wherein the computer program causes the at least one processor to further perform the following functions:
displaying the video by playing back the video from an initial playback position; and
displaying a message sent and received between the user and another user who belong to a specific group among a plurality of groups created for the public venue for a plurality of users.

4. The non-transitory computer-readable medium according to claim 3, wherein the specific group is at least one of the following:
a group selected by the user from among the plurality of groups, each of which is created by one of the users;
a group to which is assigned an entry time slot corresponding to a time when the user entered the public venue, from among a plurality of groups each assigned an entry time slot; and
a group to which is assigned attribute data corresponding to attribute data registered for the user, from among a plurality of groups each assigned attribute data.

5. The non-transitory computer-readable medium according to claim 4, wherein the computer program causes the at least one processor to further perform the following function:
displaying an object to change a playback position of the video for the user between (i) the initial playback position and (ii) an earliest playback position among positions at which each of the plurality of users belonging to the specific group is playing back the video.

6. The non-transitory computer-readable medium according to claim 4, wherein the computer program causes the at least one processor to further perform the following function:
displaying an object to change a playback position of the video for the user between (i) the initial playback position and (ii) a latest playback position of the video when the playback of the video starts on schedule at the show start time at the public venue.

7. The non-transitory computer-readable medium according to claim 3, wherein the computer program causes the at least one processor to further perform the following function:
displaying the message in a real-time method without synchronizing the message with playback of the video.

8. The non-transitory computer-readable medium according to claim 3, wherein the computer program causes the at least one processor to further perform the following functions:
registering evaluation data selected, based on the operation data, from among at least one evaluation data indicating an evaluation of the video in association with a playback position of the video that can be registered by at least one of the plurality of users including the user and the other user; and
displaying a graph created in association with the playback position of the video by using the at least one evaluation data registered by the at least one user.

9. The non-transitory computer-readable medium according to claim 8, wherein, the computer program causes the at least one processor to further perform the following functions:
causing the graph to display a total number of the at least one evaluation data registered for the playback position in association with each of a plurality of playback positions, and
playing back the video from the playback position corresponding to one total number selected based on the operation data from among the total numbers included in the graph.

10. The non-transitory computer-readable medium according to claim 1, wherein the computer program causes the at least one processor to further perform the following functions:
displaying a message list in which at least one message sent by the user is registered in association with a playback position of the video; and
playing back the video from the playback position corresponding to one message selected, based on the operation data, from among the at least one message included in the message list.

11. The non-transitory computer-readable medium according to claim 1, wherein the computer program causes the at least one processor to further perform the following function:
allowing the video to play back until a fixed period of time has elapsed from a time when the video was played back to a final playback position.

12. The non-transitory computer-readable medium according to claim 1, wherein the computer program causes the at least one processor to further perform the following function:
displaying an avatar of the user at the public venue based on the operation data when it is determined that the selected time is included in the entry-allowed time slot.

13. The non-transitory computer-readable medium according to claim 1, wherein the computer program causes the at least one processor to further perform the following function:
displaying the entry-allowed time slot including (i) a front end time before the show start time determined for the public venue and (ii) the entry end time.

14. The non-transitory computer-readable medium according to claim 1, wherein the computer program causes the at least one processor to further perform the following function:
receiving, from the server device via a communication line, data related to the entry-allowed time slot.

15. A method executed by at least one processor that executes computer-readable commands, the method comprising, by the at least one processor executing the commands:
displaying, based on operation data indicating content of an operation of a user, a virtual space that accommodates a virtual public venue for showing a video;
displaying an entry-allowed time slot that includes at least (i) a show start time that is specified for the public venue and (ii) an entry end time obtained by adding an allowed time to the show start time;
determining whether a time at which the public venue is selected based on the operation data as a venue to be entered is included in the entry-allowed time slot of the public venue; and
in response to determining that the time at which the public venue is selected is included in the entry-allowed time slot, receiving a video specified for the public venue from a server device and displaying the video.

16. The method according to claim 15, further comprising:
receiving, from the server device via a communication line, data related to the entry-allowed time slot.

17. A method executed by at least one processor that executes computer-readable commands, the method comprising, by the at least one processor executing the commands:
sending, to a terminal device of a user, data related to an entry-allowed time slot that includes at least (i) a show start time that is specified for a virtual public venue, accommodated in a virtual space, for showing a video and (ii) an entry end time obtained by adding an allowed time to the show start time;
determining whether a time at which the public venue was selected by the terminal device as a venue to be entered is included in the entry-allowed time slot of the public venue; and
in response to determining that the time at which the public venue was selected is included in the entry-allowed time slot, sending, to the terminal device, a video specified for the public venue.

18. The method according to claim 17, further comprising
sending, to the terminal device via a communication line, data related to the entry-allowed time slot.

19. A server device provided with at least one processor, the at least one processor being configured to perform the following functions:
sending, to a terminal device of a user, data related to an entry-allowed time slot that includes at least (i) a show start time that is specified for a virtual public venue, accommodated in a virtual space, for showing a video and (ii) an entry end time obtained by adding an allowed time to the show start time;
determining whether a time at which the public venue was selected by the terminal device as a venue to be entered is included in the entry-allowed time slot of the public venue; and
in response to determining that the time at which the public venue was selected is included in the entry-allowed time slot, sending, to the terminal device, a video specified for the public venue.

20. The server device according to claim 19, wherein
the at least one processor is further configured to send, to the terminal device via a communication line, data related to the entry-allowed time slot.
